(19) United States
(12) Patent Application Publication
(10) Pub. No.: US 2012/0197797 A1
(43) Pub. Date: Aug. 2, 2012

(54) PENDING ATM TRANSACTIONS

(75) Inventors: David M. Grigg, Rock Hill, SC (US); Elizabeth S. Votaw, Potomac, MD (US); Alicia C. Jones, Fort Mill, SC (US); Patrick Brian Kelly, Charlotte, NC (US); Cindy Elizabeth Kerber, Cornelius, NC (US); Marc B. Keller, Charlotte, NC (US)

(73) Assignee: BANK OF AMERICA CORPORATION, Charlotte, NC (US)

(21) Appl. No.: 13/018,288

(22) Filed: Jan. 31, 2011

(51) Int. Cl. G06Q 40/00

(52) U.S. Cl. 705/43

(57) ABSTRACT

In general terms, embodiments of the present invention relate to methods and apparatuses for initiating pending ATM transactions on a mobile device and for completing those pending ATM transactions at an ATM. For example, in some embodiments, a method is provided that includes: (a) initiating a pending ATM transaction on a mobile device, where the initiating the pending ATM transaction is based at least partially on a user of the mobile device inputting one or more inputs into the mobile device, and where the initiating the pending ATM transaction occurs before the user arrives at an ATM for completing the pending ATM transaction; (b) storing, on the mobile device, transaction information associated with the pending ATM transaction; (c) transferring the transaction information from the mobile device directly to the ATM, where the transferring the transaction information occurs after the user arrives at the ATM for completing the pending ATM transaction; (d) receiving, at the ATM, the transaction information associated with the pending ATM transaction; and (e) completing, at the ATM, the pending ATM transaction based at least partially on the transaction information.

### BACKGROUND

Today, many financial institution customers regularly visit automated teller machines (ATMs) in order to deposit checks, withdrawal cash, and/or perform one or more other ATM transactions. However, the process of engaging in a transaction at an ATM (which may include traveling to the ATM, waiting in line at the ATM, interacting with the ATM, authenticating the customer at the ATM, etc.) is increasingly viewed by financial institution customers as burdensome, time-consuming, and inefficient. Thus, there is a need to provide methods and apparatuses that enable financial institution customers to engage in ATM transactions in ways that are easier, faster, and more efficient than the ways disclosed in the prior art.

### BRIEF SUMMARY OF SOME EMBODIMENTS OF THE PRESENT INVENTION

### Brief Overview

In general terms, embodiments of the present invention relate to methods and apparatuses for initiating pending ATM transactions and/or pending ATM authentications on a mobile device, and for completing those pending ATM transactions and/or pending ATM authentications at an ATM. Although the pending ATM transactions concept and the pending ATM authentications concept are mostly discussed separately herein, it will be understood that, where possible, embodiments of the present invention that incorporate one concept may include any of the advantages, features, functions, apparatuses, and/or operational aspects of the other concept, and vice versa.

### Brief Summary of Pending ATM Transactions

Some embodiments of the present invention relate to methods and apparatuses for initiating pending ATM transactions on a mobile device and for completing those pending ATM transactions at an ATM. For example, in some embodiments, a user of a mobile phone inputs, into the mobile phone, transaction information associated with a cash withdrawal transaction (e.g., withdrawal amount, account number/nickname, the specific ATM for completing the cash withdrawal transaction, etc.) before the user arrives at the ATM for completing the cash withdrawal transaction. In so doing, the mobile phone may initiate a pending cash withdrawal transaction on the mobile phone, such that transaction information associated with that pending cash withdrawal transaction can later be transferred from the mobile phone directly to the ATM when the user arrives at the ATM for completing the pending cash withdrawal transaction. Accordingly, some embodiments of the present invention enable an ATM user to perform at least a portion of an ATM transaction on a mobile device while the user is: (a) at home, at work, waiting in line to use the ATM, and/or otherwise located remotely from the ATM; and/or (b) before the user arrives at the ATM for completing the ATM transaction. Among other things, some embodiments of the present invention may improve customer satisfaction by reducing the amount of necessary interaction between an ATM user and the ATM and/or by reducing the time it takes to perform one or more ATM transactions.

As an example, some embodiments of the present invention provide a method that includes: (a) initiating a pending ATM transaction on a mobile device, where the initiating is based at least partially on a user of the mobile device inputting one or more inputs into the mobile device, and where the initiating occurs before the user arrives at an ATM for completing the pending ATM transaction; (b) storing, on the mobile device, transaction information associated with the pending ATM transaction; and (c) transferring the transaction information from the mobile device directly to the ATM, where the ATM is configured to complete the pending ATM transaction based at least partially on the transaction information, and where the transferring occurs after the user arrives at the ATM for completing the pending ATM transaction.

In some embodiments, the method further includes generating, on the mobile device, the transaction information based at least partially on the one or more inputs, where the generating the transaction information occurs before the transferring the transaction information. In some of these embodiments, the generating the transaction information includes generating, on the mobile device, a token based at least partially on the one or more inputs. Additionally or alternatively, in some embodiments, the storing the transaction information includes storing the token on the mobile device, and the transferring the transaction information from the mobile device directly to the ATM includes transferring the token from the mobile device directly to the ATM.

In some embodiments of the method, neither the transaction information nor information based at least partially on the one or more inputs is transferred from the mobile device during the period of time that extends between the initiating the pending ATM transaction and the transferring the transaction information. In some embodiments, the method further includes authenticating the user at the mobile device before the initiating the pending ATM transaction. In other embodiments, the method includes prompting, at the mobile device, the user to input the one or more inputs into the mobile device. In still other embodiments, the method includes authenticating the user at the ATM after the user arrives at the ATM for completing the pending transaction.

In some embodiments, the method includes prompting, at the ATM, the user to transfer the transaction information from the mobile device to the ATM. In some embodiments, the method includes prompting, at the mobile device, the user to select the pending ATM transaction for transfer. In still other embodiments, the method includes prompting, at the ATM, the user to select the pending ATM transaction for completion, where the prompting occurs after the transferring the transaction information. In some of these embodiments, the method further includes completing the pending ATM transaction at the ATM, where the completing the pending ATM transaction occurs automatically after the user selects the pending ATM transaction so that the pending ATM transaction is completed without any additional action by the user.

In some embodiments of the method, the transaction information identifies the mobile device and an account held by the user. In some of these embodiments, the method further includes determining, at the ATM, that the mobile device is associated with the account. Additionally or alternatively, in some embodiments, the method further includes removing the transaction information from the mobile device after the transferring the transaction information. In some embodiments, the method includes completing the pending ATM transaction at the ATM.

In some embodiments of the method, the pending ATM transaction is valid only for a predetermined period of time. Additionally or alternatively, in some embodiments, the pending ATM transaction is valid only for a predetermined ATM. In other embodiments, the mobile device includes a first near field communication (NFC) interface and the ATM includes a second NFC interface. In some of these embodiments, the transferring the transaction information includes transferring the transaction information from the first NFC interface directly to the second NFC interface. In some embodiments of the method, the mobile device includes a mobile phone. In other embodiments of the method, the pending ATM transaction includes a cash withdrawal transaction.

Other embodiments of the present invention provide a mobile device that includes: (a) a user interface configured to receive one or more inputs from a user of the mobile device; (b) a memory device; (c) a processor operatively connected to the user interface and the memory device, and configured to: (i) initiate a pending ATM transaction, where the processor initiates the pending ATM transaction based at least partially on the one or more inputs, and where the processor initiates the pending ATM transaction before the user arrives at an ATM for completing the pending ATM transaction; and (ii) store, in the memory device, transaction information associated with pending ATM transaction; and (d) a communication interface operatively connected to the processor and configured to transfer the transaction information from the memory device to the ATM, where the ATM is configured to complete the pending ATM transaction based at least partially on the transaction information, and where the communication interface transfers the transaction information after the user arrives at the ATM for completing the pending ATM transaction.

Still other embodiments of the present invention provide a computer program product having a non-transitory computer-readable medium. In some embodiments, the non-transitory computer-readable medium includes one or more computer-executable program code portions that, when executed by a mobile device, cause the mobile device to: (a) initiate a pending ATM transaction on the mobile device, where the mobile device initiates the pending ATM transaction based at least partially on a user of the mobile device inputting one or more inputs into the mobile device, and where the mobile device initiates the pending ATM transaction before the user arrives at an ATM for completing the pending ATM transaction; (b) store, on the mobile device, transaction information associated with the pending ATM transaction; and (c) transfer the transaction information from the mobile device directly to the ATM, where the ATM is configured to complete the pending ATM transaction based at least partially on the transaction information, and where the mobile device transfers the transaction information after the user arrives at the ATM for completing the pending ATM transaction.

Other embodiments of the present invention provide a method that includes: (a) receiving, at an ATM and directly from a mobile device, transaction information associated with one or more pending ATM transactions; and (b) completing, at the ATM, the one or more pending ATM transactions based at least partially on the transaction information.

In some embodiments, the method further includes prompting, via a user interface associated with the ATM, the user to transfer the transaction information from the mobile device directly to the ATM. In other embodiments of the method, the completing the one or more pending ATM transactions occurs automatically after the receiving the transaction information so that the one or more pending ATM transactions are completed without any additional action by a user of the ATM.

In some embodiments of the method, the transaction information includes information associated with an account, and in some of these embodiments, the method further includes determining, at the ATM, that the mobile device is associated with the account. In some embodiments of the method, the one or more pending ATM transactions are valid only for a predetermined period of time. In other embodiments of the method, the one or more pending ATM transactions are valid only for the ATM.

In some embodiments, the method further includes: (a) prompting, via a user interface associated with the ATM, the user to select one or more of the one or more pending ATM transactions for completion; and (b) receiving, via the user interface, the user's one or more selections. In some embodiments, the method further includes authenticating the user at the ATM.

### Brief Summary of Pending ATM Authentications

In today's world, an ATM user usually must be authenticated at an ATM before that ATM will initiate, perform, complete, and/or otherwise facilitate an ATM transaction. For example, the user typically presents a debit card and inputs a PIN associated with that debit card at the ATM in order to verify, confirm, and/or prove (e.g., to the ATM, to an authorization apparatus, etc.): (a) the identity of the user; (b) that the user is who he says he is; (b) that the user is authorized to engage in ATM transactions using the debit card; and/or (d) that the user is authorized to engage in transactions involving the account that is associated with the debit card. However, this process of authorization and/or authentication (sometimes collectively referred to herein as “authentication process” for simplicity) can be slow and/or burdensome to perform. In addition, this authentication process may also be vulnerable to fraudsters trying to capture and/or otherwise steal authentication information that is typically presented and/or input at ATMs (e.g., by placing a camera over the ATM keypad, by using a skimmer, etc.).

To improve over these deficiencies, some embodiments of the present invention relate to methods and apparatuses for initiating pending ATM authentications on a mobile device and for completing those pending ATM authentications at an ATM. More specifically, in some embodiments, a user of a mobile device inputs, into the mobile device, authentication information associated with the user (e.g., name, username, password, PIN, social security number, authentication challenge answer, etc.) that can be used (and/or is required) to authenticate the user at the ATM. In some embodiments, the user inputs this authentication information into the mobile device before the user arrives at the ATM for completing an ATM transaction. In so doing, the mobile device may initiate a pending ATM authentication on the mobile device, such that authentication information associated with the user (e.g., the same or different information input by the user, etc.) can later be transferred from the mobile device directly to the ATM when the user arrives at the ATM for completing the pending ATM authentication. Accordingly, some embodiments of the present invention enable an ATM user to perform at least a portion of the ATM authentication process on a mobile device: (a) while the user is at home, at work, waiting in line to use the ATM, and/or otherwise located remotely from the ATM; and/or (b) before the user arrives at the ATM for completing the ATM authentication and/or one or more ATM transactions (e.g., one or more pending ATM transactions and/or conventional ATM transactions, etc.). Among other things, some embodiments of the present invention may improve customer satisfaction by reducing the amount of necessary interaction between the ATM user and the ATM and/or by reducing the time it takes to authenticate the user at the ATM. In addition, by transferring the authentication information from the mobile device directly to the ATM, some embodiments of the present invention may impede and/or prevent fraudsters from using cameras and/or skimmers to steal authentication information.

As an example, some embodiments of the present invention provide a method that includes: (a) initiating a pending ATM authentication on a mobile device, where the initiating is based at least partially on a user of the mobile device inputting one or more inputs into the mobile device, and where the initiating occurs before the user arrives at an ATM for completing the pending ATM authentication; (b) storing, on the mobile device, authentication information associated with the pending ATM authentication; and (c) transferring the authentication information from the mobile device directly to the ATM, where the ATM is configured to complete the pending ATM authentication based at least partially on the authentication information, and where the transferring occurs after the user arrives at the ATM for completing the pending ATM authentication.

In some embodiments, the method further includes generating, on the mobile device, the authentication information based at least partially on the one or more inputs, where the generating the authentication information occurs before the transferring the authentication information. Additionally or alternatively, in some embodiments of the method, the generating the authentication information includes generating, on the mobile device, a token based at least partially on the one or more inputs. In some of these embodiments, the storing the authentication information includes storing the token on the mobile device, and the transferring the authentication information from the mobile device directly to the ATM includes transferring the token from the mobile device directly to the ATM. In some embodiments of the method, neither the authentication information nor information based at least partially on the one or more inputs is transferred from the mobile device during the period of time that extends between the initiating the pending ATM authentication and the transferring the authentication information.

In other embodiments, the method further includes: (a) transferring, from the mobile device and to an authentication apparatus, information associated with the one or more inputs, where the authentication apparatus is configured to generate the authentication information based at least partially on the information associated with the one or more inputs; and (b) receiving, at the mobile device and from the authentication apparatus, the authentication information. In some of these embodiments, the transferring the information associated with the one or more inputs and the receiving the authentication information occur before the user arrives at the ATM for completing the pending ATM authentication.

In some embodiments, the method further includes authenticating the user at the mobile device before the initiating the pending ATM authentication. Additionally or alternatively, in some embodiments, the method further includes prompting, at the mobile device, the user to input the one or more inputs into the mobile device. In some embodiments, the method further includes prompting, at the ATM, the user to transfer the authentication information from the mobile device to the ATM, where the prompting occurs before the transferring the authentication information. In other embodiments, the method includes prompting, at the mobile device, the user to select the pending ATM authentication for transfer, where the prompting occurs before the transferring the authentication information.

In some embodiments of the method, the authentication information identifies the mobile device and an account held by the user, and in some of these embodiments, the method further includes determining, at the ATM, that the mobile device is associated with the account. Additionally or alternatively, in some embodiments, the method further includes removing the authentication information from the mobile device after the transferring the authentication information. In some embodiments, the method includes completing the pending ATM authentication at the ATM. In some of these embodiments, the completing the pending ATM authentication occurs automatically, without any additional action by the user, after the transferring the authentication information.

In some embodiments, the pending ATM authentication is valid only for a predetermined period of time. Additionally or alternatively, in some embodiments, the pending ATM authentication is valid only for a predetermined ATM. Also, in some embodiments of the method, the mobile device includes a first NFC interface and the ATM includes a second NFC interface. In some of these embodiments, the transferring the authentication information includes transferring the authentication information from the first NFC interface directly to the second NFC interface.

In some embodiments of the method, the mobile device includes a mobile phone. Additionally or alternatively, in some embodiments, the method further includes: (a) initiating a pending ATM transaction on the mobile device, where the initiating is based at least partially on the user of the mobile device inputting one or more inputs into the mobile device, and where the initiating occurs before the user arrives at the ATM for completing the pending ATM transaction; (b) storing, on the mobile device, transaction information associated with the pending ATM transaction; and (c) transferring the transaction information from the mobile device directly to the ATM, where the ATM is configured to complete the pending ATM transaction based at least partially on the transaction information, and where the transferring occurs after the user arrives at the ATM for completing the pending ATM transaction.

Other embodiments of the present invention provide a mobile device that includes: (a) a user interface configured to receive one or more inputs from a user of the mobile device; (b) a memory device; (c) a processor operatively connected to the user interface and the memory device, and configured to: (i) initiate a pending ATM authentication, where the processor initiates the pending ATM authentication based at least partially on the one or more inputs, and where the processor initiates the pending ATM authentication before the user arrives at an ATM for completing the pending ATM authentication; and (ii) store, in the memory device, authentication information associated with pending ATM authentication; and (d) a communication interface operatively connected to the processor and configured to transfer the authentication information from the memory device to the ATM, where the ATM is configured to complete the pending ATM authentication based at least partially on the authentication information, and where the communication interface transfers the authentication information after the user arrives at the ATM for completing the pending ATM authentication.

Still other embodiments of the present invention provide a computer program product including a non-transitory computer-readable medium. In some embodiments, the non-transitory computer-readable medium includes one or more computer-executable program code portions that, when executed by a mobile device, cause the mobile device to: (a) initiate a pending ATM authentication on the mobile device, where the mobile device initiates the pending ATM authentication based at least partially on a user of the mobile device inputting one or more inputs into the mobile device, and where the mobile device initiates the pending ATM authentication before the user arrives at an ATM for completing the pending ATM authentication; (b) store, on the mobile device, authentication information associated with the pending ATM authentication; and (c) transfer the authentication information from the mobile device directly to the ATM, where the ATM is configured to complete the pending ATM authentication based at least partially on the authentication information, and where the mobile device transfers the authentication information after the user arrives at the ATM for completing the pending ATM authentication.

Other embodiments of the present invention provide a method that includes: (a) receiving, at an ATM and directly from a mobile device, authentication information associated with a pending ATM authentication; and (b) completing, at the ATM, the pending ATM authentication based at least partially on the authentication information. In some embodiments, the method further includes prompting, via a user interface associated with the ATM, the user to transfer the authentication information from the mobile device directly to the ATM. In other embodiments, the completing the pending ATM authentication occurs automatically after the receiving the authentication information so that the pending ATM authentication is completed at the ATM without any additional action by a user of the ATM.

In some embodiments of the method, the authentication information includes information associated with an account. In some of these embodiments, the method further includes determining, at the ATM, that the mobile device is associated with the account. Additionally or alternatively, in some embodiments, the method further includes: (a) receiving, at the ATM and directly from the mobile device, transaction information associated with one or more pending ATM transactions; and (b) completing, at the ATM, the one or more pending ATM transactions based at least partially on the transaction information.

### BRIEF DESCRIPTION OF THE DRAWINGS

Having thus described some embodiments of the present invention in general terms, reference will now be made to the accompanying drawings, wherein:

FIG. 1 is a flow diagram illustrating a general process flow for initiating a pending ATM transaction on a mobile device and for completing the pending ATM transaction at an ATM, in accordance with an embodiment of the present invention;

FIG. 2 is a flow diagram illustrating a more-detailed general process flow for initiating a pending ATM transaction on a mobile device and for completing the pending ATM transaction at an ATM, in accordance with an embodiment of the present invention;

FIG. 3 is a block diagram illustrating technical components of a system for initiating and completing pending ATM transactions and/or pending ATM authentications, in accordance with an embodiment of the present invention;

FIG. 3A is a block diagram illustrating technical components of a mobile device configured to initiate pending ATM transactions and/or pending ATM authentications, in accordance with an embodiment of the present invention;

FIG. 4 is a mixed block and flow diagram of a system for initiating a pending ATM transaction on an NFC-enabled mobile phone and for completing the pending ATM transaction at an NFC-enabled ATM, in accordance with an embodiment of the present invention;

FIG. 5 is a flow diagram illustrating a general process flow for initiating a pending ATM authentication on a mobile device and for completing the pending ATM authentication at an ATM, in accordance with an embodiment of the present invention;

FIG. 6 is a flow diagram illustrating a more-detailed general process flow for initiating a pending ATM authentication on a mobile device and for completing the pending ATM authentication at an ATM, in accordance with an embodiment of the present invention; and

FIG. 7 is a mixed block and flow diagram of a system for initiating a pending ATM authentication on an NFC-enabled mobile phone and for completing the pending ATM authentication at an NFC-enabled ATM, in accordance with an embodiment of the present invention.

### DETAILED DESCRIPTION OF EMBODIMENTS OF THE PRESENT INVENTION

### Overview

In general terms, embodiments of the present invention relate to methods and apparatuses for initiating pending ATM transactions and/or pending ATM authentications on a mobile device, and for completing those pending ATM transactions and/or pending ATM authentications at an ATM. Although the pending ATM transactions concept and the pending ATM authentications concept are mostly discussed separately herein, it will be understood that, where possible, embodiments of the present invention that incorporate one concept may include any of the advantages, features, functions, apparatuses, and/or operational aspects of the other concept, and vice versa.

### Pending ATM Transactions

In general terms, some embodiments of the present invention relate to methods and apparatuses for initiating pending ATM transactions on a mobile device and for completing those pending ATM transactions at an ATM. For example, in some embodiments, a user of a mobile phone inputs, into the mobile phone, transaction information associated with a cash withdrawal transaction (e.g., withdrawal amount, account number/nickname, the specific ATM for completing the cash withdrawal transaction, etc.) before the user arrives at the ATM for completing the cash withdrawal transaction. In so doing, the mobile phone may initiate a pending cash withdrawal transaction on the mobile phone, such that transaction information associated with that pending cash withdrawal transaction can later be transferred from the mobile phone directly to the ATM when the user arrives at the ATM for completing the pending cash withdrawal transaction. Accordingly, embodiments of the present invention enable an ATM user to perform at least a portion of an ATM transaction on a mobile device: (a) while the user is at home, at work, waiting in line to use the ATM, and/or otherwise located remotely from the ATM; and/or (b) before the user arrives at the ATM for completing the ATM transaction. Among other things, some embodiments of the present invention may improve customer satisfaction by reducing the amount of necessary interaction between the ATM user and the ATM and/or by reducing the time it takes to perform one or more ATM transactions.

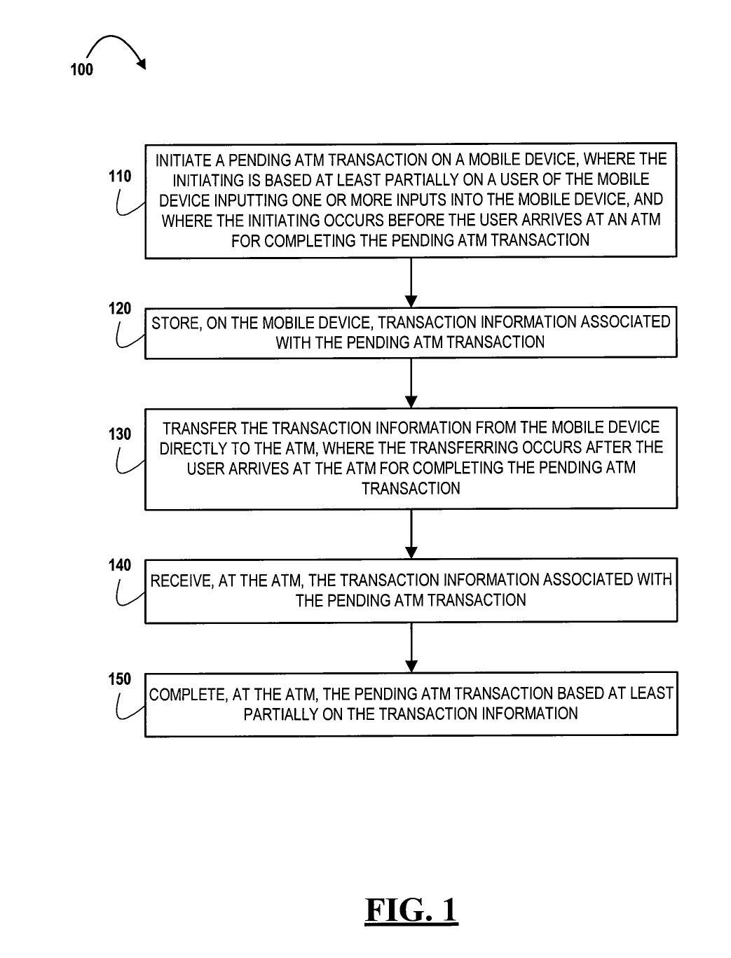

Referring now to FIG. 1, a general process flow 100 is provided for initiating a pending ATM transaction on a mobile device and for completing the pending ATM transaction at an ATM, in accordance with an embodiment of the present invention. In some embodiments, the process flow 100 is performed, in combination, by a mobile device (i.e., one or more mobile devices) and an ATM (i.e., one or more ATMs), where each has hardware and/or software configured to perform one or more portions of the process flow 100. In such embodiments, as represented by block 110, the mobile device is configured to initiate a pending ATM transaction on the mobile device, where the initiating is based at least partially on a user of the mobile device inputting one or more inputs into the mobile device, and where the initiating occurs before the user arrives at an ATM for completing the pending ATM transaction. As represented by block 120, the mobile device is also configured to store, on the mobile device, transaction information associated with the pending ATM transaction. In addition, as represented by block 130, the mobile device is configured to transfer the transaction information from the mobile device directly to the ATM, where the transferring occurs after the user arrives at the ATM for completing the pending ATM transaction. Thereafter, as represented by block 140, the ATM is configured to receive the transaction information associated with the pending ATM transaction. Then, as represented by block 150, the ATM is configured to complete the pending ATM transaction based at least partially on the transaction information.

Regarding block 110, the mobile device can include any number and/or type of mobile device(s). Examples of mobile devices include mobile phones (e.g., feature phones, smart phones, iPhones®, Droids®, etc.), mobile gaming devices (e.g., PlayStation Portable®, etc.), mobile computers (e.g., tablet computers, laptop computers, etc.), personal digital assistants (PDAs), and/or the like. In some embodiments, the mobile device is configured to send and/or receive communications (e.g., phone calls, text messages, SMS messages, actionable alerts, emails, social media-specific messages, etc.), present information via a user interface, prompt a user of the mobile device to perform some action, play video games, browse the Internet, and/or the like. In some embodiments, the mobile device is portable (e.g., not stationary) and/or is carried and/or worn by and/or on a person (e.g., the user referred to in block 110). Additionally or alternatively, in some embodiments, the mobile device is controlled, serviced, owned, managed, operated, and/or maintained (collectively referred to herein as “maintained” for simplicity) by a person (e.g., the user) and/or by a financial institution.

In some embodiments, the mobile device includes one or more near field communication (NFC) interfaces that are configured to communicate with one or more NFC interfaces associated with the ATM. For example, in some embodiments, the NFC interface of the mobile device can communicate transaction information (e.g., account names, routing numbers, account numbers, transaction amounts, etc.) directly with the NFC interface of the ATM. In some of these embodiments, the mobile device is configured to operate as a mobile wallet, meaning that the mobile device can be used to, for example, make payments, transfer transaction information, and/or otherwise engage in transactions at the ATM.

As used herein, the phrase “NFC interface” generally refers to hardware and/or software that is configured to contactlessly and/or wirelessly send and/or receive information over relatively short ranges (e.g., within four inches, within three feet, etc.). An NFC interface may include one or more transmitters, receivers, smart cards, key cards, proximity cards, Bluetooth® devices, radio frequency identification (RFID) tags and/or readers, and/or the like. In some embodiments, the NFC interface communicates information via radio, infrared (IR), and/or optical transmissions.

Further regarding block 110, the phrase “pending ATM transaction” generally refers to an ATM transaction that has been initiated but not yet completed. It will be understood that an ATM transaction (and/or a pending ATM transaction) can include any number and/or type of transaction(s) involving an ATM. For example, in some embodiments, the pending ATM transaction referred to in block 110 is for: withdrawing cash; depositing cash and/or checks; checking account balances; making payments to creditors (e.g., paying monthly bills; paying federal, state, and/or local taxes and/or bills; etc.); sending remittances; transferring balances from one account to another account; loading money onto stored value cards; donating to charities; and/or the like.

In some embodiments, the pending ATM transaction involves an account, and in some embodiments, that account is held by the user referred to in block 110. For example, in some embodiments, the pending ATM transaction involves an account held by the user because the pending ATM transaction includes withdrawing cash from the account held by the user. It will be understood that the account involved in the pending ATM transaction can include any number and/or type of account(s). For example, in some embodiments, the account includes a checking account, savings account, money market account, investment account, brokerage account, certificate of deposit account, and/or any other type of deposit account. In some embodiments, the deposit account is one or more accounts that can incur an overdraft and/or be overdrawn.

In some embodiments, the account, the ATM, and the mobile device are each maintained by a single financial institution. For example, in some embodiments, the mobile device is owned by a bank and issued to the user, the account is maintained by the bank, the ATM is owned by the bank, and the user is a customer of the bank and the holder of an account involved in the pending ATM transaction. Of course, it will be understood that, in some embodiments, the mobile device, the ATM, and the account are not maintained by the same financial institution (or any financial institution).

In some embodiments, the pending ATM transaction remains pending for at least one minute, two minutes, one hour, three days, one month, and/or some other non-trivial and/or appreciable period of time before being completed. In some embodiments, the pending ATM transaction remains pending on the mobile device until deleted and/or removed from the mobile device by the user. In some embodiments, the pending ATM transaction is only valid for a predetermined period of time. In other words, in some embodiments, the pending ATM transaction may expire. For example, in some embodiments, a pending ATM transaction is only valid for, and/or will expire after, five minutes, two hours, one day, etc. after being initiated and/or stored on the mobile device (and/or in a pending ATM transaction queue). In such embodiments, if the pending ATM transaction is not completed at an ATM within that period of time, the ATM may not be able to complete the pending ATM transaction, and/or the pending ATM transaction (and/or transaction information associated therewith) may be removed, erased, and/or deleted from the mobile device. In some embodiments, the user can select (e.g., via the one or more inputs) when the pending ATM transaction is to expire and/or for how long the pending ATM transaction is to remain valid.

Still referring to block 110, the one or more user inputs may include and/or communicate any amount and/or type of information. In some embodiments, the one or more user inputs include transaction information, and in some embodiments, although not required, this is the same transaction information referred to in the block 130 that is transferred to the ATM. In some embodiments, transaction information is any information that identifies, defines, describes, and/or is otherwise associated with a pending ATM transaction. Exemplary transaction information includes, but is not limited to, account numbers, account nicknames, tokens (e.g., transaction codes, nickname, software tokens, access tokens, information packages, data packets, widgets, transaction identifiers, etc.), the identity of the party(ies) involved in the pending ATM transaction, the date and/or time that the pending ATM transaction is initiated and/or will be completed, the specific ATM that will complete the pending ATM transaction, how long the pending ATM transaction is valid and/or when the pending ATM transaction will expire, the account(s) involved in the pending ATM transaction, the status of the pending ATM transaction (e.g., initiated, pending, authorized, completed, etc.), the transaction amount associated with the pending ATM transaction, the description of the pending ATM transaction (which, itself, can include any transaction information, e.g., the description may describe the transaction status, the transaction amount, the transaction type, etc.), and/or the like.

The transaction information can also include any information that defines and/or identifies the type of the pending ATM transaction (e.g., cash withdrawal transaction, check deposit transaction, etc.). In some embodiments, the transaction type is defined, at least in part, by the one or more instruments and/or methods used to conduct the transaction, such as, for example, paper checks, electronic checks, debit cards, ATM cards, checkcards, wire transfers, online bill pay, automated clearing house (ACH), contactless payments, near field communication (NFC) interface payments, cash payments, and/or the like. Also, it will be understood that, for simplicity, the phrase “pending ATM transaction” is sometimes used herein to mean “transaction information associated with the pending ATM transaction,” and/or vice versa.

Further, it will be understood that any given pending ATM transaction may have more than one transaction type. For example, in accordance with some embodiments, a cash withdrawal transaction conducted at the ATM may be defined as a cash-related transaction, a withdrawal transaction, and/or an ATM transaction. As another example, in accordance with some embodiments, a purchase transaction involving the ATM and the mobile device, where each of the ATM and the mobile device has an NFC interface, may be defined as a purchase transaction, an ATM transaction, mobile device transaction, an NFC interface transaction, and/or a contactless payment transaction.

Still referring to block 110, the one or more inputs may be input by the user of the mobile device in any way. For example, in some embodiments, the mobile device includes a keyboard, microphone, and/or one or more other user input devices for inputting the one or more user inputs. As another example, in some embodiments, the mobile device presents, via a touchscreen display of the mobile device, one or more fields, buttons, drop-down menus, and/or other user interface features that enable the customer to input and/or communicate information to the mobile device. In some embodiments, the user actually enters account numbers, transaction amounts, payee names, and/or other information into the mobile device, whereas, in other embodiments, the user communicates information to the mobile device by selecting buttons and/or other user interface features that are provided to the user by the mobile device.

Also, it will be understood that the mobile device may initiate the pending ATM transaction in any way. For example, in some embodiments, the pending ATM transaction is initiated when transaction information associated with the pending ATM transaction is communicated to, input into, and/or otherwise received by the mobile device (e.g., as a result of the user inputting the one or more inputs referred to in block 110, as a result of the mobile device receiving the transaction information from another apparatus, etc.). As another example, in some embodiments, the pending ATM transaction is initiated when a token associated with the pending ATM transaction (e.g., information package, widget, transaction code, transaction identifier, etc.) is generated and/or stored on the mobile device (e.g., placed into a pending ATM transaction queue stored on the mobile device).

Regarding block 120, the mobile device can be configured to store the transaction information associated with the pending ATM transaction on the mobile device in any way. In some embodiments, the transaction information is stored in the memory of the mobile device. This memory may be non-temporary, non-volatile, and/or long-term persistent memory, but in some embodiments, in addition to or instead of storing the transaction information in non-temporary, non-volatile, and/or long-term persistent memory, the mobile device stores the transaction information in temporary and/or volatile memory. It will be understood that, in some embodiments, the transaction information is stored on the mobile device if the ATM and/or the user of the mobile device can retrieve the transaction information from the mobile device sometime after the transaction information is stored therein.

In some embodiments, the mobile device is configured to store the transaction information in a pending ATM transaction queue on the mobile device. In some embodiments, this queue is stored in the memory of the mobile device. As a specific example, in some embodiments, the mobile device is configured to generate a token associated with the pending ATM transaction (e.g., information packages having information associated with the pending ATM transaction therein, a transaction code, a transaction identifier, etc.) and then place that token into the pending ATM transaction queue. In some embodiments, the token is presented, via a user interface of the mobile device, to the user of the mobile device, such that the user may determine and/or view which pending ATM transactions are stored in the queue. In addition, after arriving at the ATM, the token may be transferred from the pending ATM transaction queue of the mobile device directly to the ATM, such that the ATM can complete the pending ATM transaction based at least partially on the token. In some embodiments, the token is readable and/or executable by the ATM, even though, in some embodiments, the token is not readable to, and/or viewable by, the user of the mobile device. In some embodiments, the token is removed, deleted, and/or erased from the pending ATM transaction queue after the pending ATM transaction is completed by the ATM and/or after the token is transferred to the ATM. Also, it will be understood that the pending ATM transaction queue described and/or contemplated herein may be organized and/or viewable to the user of the mobile device as a list, table, dashboard, transaction ledger, and/or in some other format. Further, in accordance with some embodiments, pending ATM transactions may be stored in the pending ATM transaction queue in the order they were initiated.

Regarding block 130, the phrase “transfer the transaction information” is meant to be understood in its broadest sense. Thus, in some embodiments, the mobile device is configured to send the transaction information from the mobile device to the ATM, whereas, in other embodiments, the ATM is configured to retrieve the transaction information from the mobile device. Also, the phrase “from the mobile device directly to the ATM” is also meant to be understood in its broadest sense. In other words, the transaction information can be transferred in any way, so long as the transaction information is transferred directly between the mobile device and the ATM without being passed through, for example, a host computer, back end network device, a bank server, and/or some other apparatus separate from the mobile device and ATM that has a processor. In some embodiments, the transaction information may pass directly from the mobile device to the ATM via one or more radio, IR, NFC, LAN, Wi-Fi, wireless, and/or wireline interfaces, links, and/or connections. It will be understood that the mobile device can be configured to transfer the transaction information from the mobile device directly to the ATM even when the mobile device is powered off (e.g., using an RFID tag), does not have cellular phone/data service (e.g., using a Wi-Fi connection), and/or does not have a Wi-Fi and/or wireless connection (e.g., using a wireline connection).

Additionally or alternatively, in some embodiments, neither the transaction information, information based at least partially on the one or more inputs referred to in block 110, nor any other information is transferred from (and/or received at) the mobile device during the period of time that extends between the initiating the pending ATM transaction (e.g., inclusive or not inclusive of that event, etc.) and the transferring the transaction information to the ATM (not inclusive of that event). In other words, in such embodiments, the mobile device is configured to perform the portions of the process flow 100 represented by blocks 110-130 itself and without any assistance from another apparatus (e.g., without a transaction apparatus generating the transaction information and sending that transaction information to the mobile device, etc.). In some embodiments, the pending ATM transaction is initiated locally (i.e., on the mobile device) and stored locally until it is time to transfer the pending ATM transaction from the mobile device to the ATM. For example, in some embodiments, the mobile device is configured to: (a) initiate a pending ATM transaction by generating a token on the mobile device, where the token includes information associated with the pending ATM transaction stored therein, and where the mobile device generates the token based at least partially on one or more inputs inputted into the mobile device by a user of the mobile device; (b) store the token on the mobile device upon or after the mobile device generates the token; and (c) then transfer the token from the mobile device directly to the ATM, where the token is never sent from the mobile device (or received at the mobile device) from the time the token is generated until the time the token is transferred to the ATM.

In other embodiments, the mobile device is not configured to perform the portions of the process flow 100 represented by blocks 110-130 entirely on its own or without assistance from another apparatus. For example, in some embodiments, after the user inputs the one or more inputs into the mobile device, the mobile device sends information associated with those one or more inputs to another apparatus (e.g., a host apparatus, back end network device, transaction apparatus, etc.), where that apparatus is configured to generate the transaction information (e.g., a token) based at least partially on the information associated with the one or more inputs. Additionally, in such embodiments, the mobile device is configured to receive, at the mobile device and from the apparatus, the transaction information (e.g., the token). In some of these embodiments, the mobile device transfers the information associated with the one or more inputs to the apparatus, the apparatus generates the transaction information (e.g., the token), and the mobile device receives the transaction information, all before the user arrives at the ATM for completing the pending ATM transaction. Thus, in such embodiments, the transaction information stored on the mobile device is not information that was originally generated by the mobile device; rather, in such embodiments, the transaction information is information that was generated by another apparatus, even though that information was based at least partially on the one or more inputs originally input into the mobile device.

It will be understood that the mobile device is configured to perform the portions of the process flow 100 represented by blocks 110 and 120 at some point when the user of the mobile device is located remotely from the ATM and/or before the user arrives at the ATM for completing the pending ATM transaction. For example, in some embodiments, the user and/or the mobile device performs the portions of the process flow 100 represented by blocks 110 and 120 while the user is at home, at work, and/or as the customer is traveling to the ATM for completing the pending ATM transaction. In some embodiments, the portions of the process flow 100 represented by blocks 110 and 120 are performed while the user is waiting in line at the ATM for other ATM customers to complete their ATM transactions. Also, it will be understood that the mobile device is configured to perform the portion of the process flow 100 represented by block 130 when or after (collectively referred to herein as “after” for simplicity) the user arrives at the ATM for completing the pending ATM transaction. In some embodiments, the customer “arrives at the ATM” when the customer is proximate to, at, and/or within arm's reach of the ATM. Additionally or alternatively, in some embodiments, the customer “arrives at the ATM” when the ATM first interacts with the user of the mobile device and/or ATM.

Regarding block 150, it will be understood that the ATM “completes” the pending ATM transaction when the ATM performs one or more meaningful actions relevant to the ATM transaction, such as, for example, dispensing cash, accepting a check deposit, printing a receipt and/or statement, loading a prepaid storage card, transferring funds, and/or the like. In some embodiments, these one or more actions constitute the exchange central to the ATM transaction, define the ATM transaction, are desired by the user to be performed, and/or were the reason the user arrived at the ATM in the first place. Also, in some embodiments, the ATM is configured to complete the pending ATM transaction automatically after the ATM receives the transaction information from the mobile device, such that the pending ATM transaction is completed without any additional action by the user.

The mobile device and ATM configured to perform the process flow 100 can be configured to perform any of the portions of the process flow 100 represented by blocks 110-150 upon or after one or more triggering events (which, in some embodiments, is one or more of the other portions of the process flow 100). As used herein, a “triggering event” refers to an event that automatically (i.e., without human intervention) triggers the execution, performance, and/or implementation of a triggered action, either immediately, nearly immediately, or sometime after (e.g., within minutes, etc.) the occurrence of the triggering event. For example, in some embodiments, the mobile device is configured such that the mobile device initiating the pending ATM transaction (the triggering event) automatically and immediately or nearly immediately triggers the mobile device to store the transaction information associated with the pending ATM transaction on the mobile device (the triggered action(s)). As another example, in some embodiments, where the mobile device and the ATM each have NFC interfaces, the mobile device is configured to automatically transfer the transaction information associated with the pending ATM transaction to the ATM (triggered action) automatically and immediately or nearly immediately after the NFC interface of the mobile device is positioned proximate to the NFC interface of the ATM (triggering event).

In some embodiments, the mobile device and ATM are configured to automatically perform one or more of the portions of the process flow 100 represented by blocks 110-150, whereas in other embodiments, one or more of the portions of the process flow 100 represented by blocks 110-150 require and/or involve human action (e.g., a user may operate the mobile device and/or the ATM to perform one or more portions of the process flow 100). In addition, it will be understood that, in some embodiments, the mobile device and/or the ATM (and/or the user thereof) is configured to perform one or more portions (or combinations of portions) of the process flow 100, from start to finish, within moments, seconds, and/or minutes (e.g., within approximately 1-15 minutes from start to finish, etc.).

It will be understood that the mobile device and/or the ATM of the process flow 100 can be configured to perform any one or more portions of any one or more embodiments described and/or contemplated herein, including, for example, any one or more portions of the process flows 200, 500, 600, and/or described later herein. Also, the number, order, and/or content of the portions of the process flow 100 are exemplary and may vary. For example, in some embodiments, the mobile device and/or the ATM are configured to identify and/or authenticate (e.g., confirm the identity of) the user of the mobile device as a condition of initiating the pending ATM transaction, storing the transaction information, transferring the transaction information from the mobile device directly to the ATM, receiving the transaction information, completing the ATM transaction, and/or performing some other action described and/or contemplated herein. In some embodiments, the mobile device and/or ATM are configured to authenticate the user based at least partially on one or more credentials (e.g., account number, username, password, PIN, ATM/debit/credit card, biometric information, barcode, etc.) the user inserts, provides, and/or presents (collectively referred to herein as “presents” for simplicity) to the mobile device and/or to the ATM. As another example, in some embodiments, the mobile device is configured to store the transaction information associated with the pending ATM transactions in an electronic banking account (e.g., online banking account, mobile banking account, SMS banking account, etc.) associated with the account involved in the pending ATM transaction.

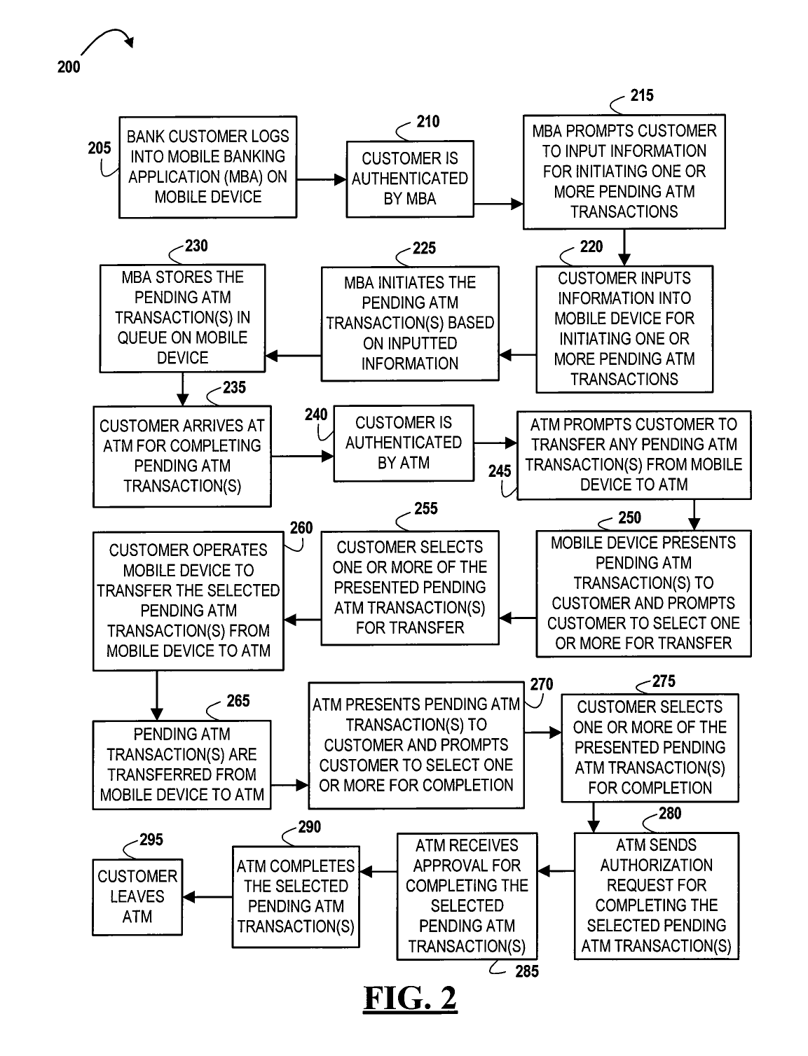

Referring now to FIG. 2, a more-detailed process flow 200 is provided for initiating a pending ATM transaction on a mobile device and for completing the pending ATM transaction at an ATM, in accordance with an embodiment of the present invention. It will be understood that the process flow 200 illustrated in FIG. 2 represents an example embodiment of the process flow 100 described in connection with FIG. 1. It will be understood that one or more portions of the process flow 200 are performed by a mobile device and/or by an ATM, and that the mobile device and the ATM each have the hardware and/or software necessary to perform those one or more portions of the process flow 200. In this example embodiment, the ATM is maintained by a bank for the benefit of its customers. Also in this example embodiment, the customer referred to in the process flow 200 is the user and owner of the mobile device, the user of the ATM, and a customer of the bank. In addition, in this example embodiment, the pending ATM transaction(s) mentioned in the process flow 200 involve one or more accounts that are held by the customer and maintained by the bank. Further, in this example embodiment, the mobile device referred to in the process flow 200 is associated with the customer, is accessible to the customer, and/or is carried, possessed, owned, and/or controlled by the customer during the performance of the portions of the process flow 200.

As represented by block 205, the bank customer logs in to a mobile banking application that executes on the mobile device. As represented by block 210, the bank customer is identified and/or authenticated by the mobile banking application and/or by the mobile device. After being authenticated, the mobile banking application prompts the customer to input information (e.g., transaction information) for initiating one or more pending ATM transactions, as represented by block 215. For example, in some embodiments, the mobile banking application presents a user interface to the customer that prompts the customer to input information associated with one or more check deposit transactions. In such embodiments, the customer may be prompted to input the number of checks for deposit, the deposit amount of each check, the identity of the payee/payor, the identity of the account (e.g., account number, account nickname, etc.) into which the checks are being deposited, and/or the like. In such embodiments, the user interface may include one or more fields, buttons, drop-down menus, and/or other user interface features that enable the customer to input and/or communicate the information. After being prompted, the customer inputs information into the mobile device for initiating one or more pending ATM transactions, as represented by block 220. It will be understood that the customer may input information for initiating more than one pending ATM transaction. For example, in some embodiments, the customer inputs information for initiating a check deposit transaction and information for initiating a cash withdrawal transaction.

After the customer inputs the information, the mobile banking application (and/or the mobile device) initiates the one or more pending ATM transactions on the mobile device and/or in the mobile banking application, as represented by block 225. Thereafter, the mobile banking application (and/or the mobile device) stores the one or more pending ATM transactions in a queue on the mobile device, as represented by block 230. For example, in some embodiments, the queue is displayed to the customer as a transaction ledger, and the ledger includes a token (e.g., “CASH WITHDRAWAL TRANSACTION FOR $100,” etc.) for each pending ATM transaction that is initiated on the mobile device. In some embodiments, the queue is populated with pending ATM transactions in the order those transactions are initiated. In some embodiments, the queue is comprised of non-temporary, non-volatile, and/or long-term persistent memory.

Sometime after the one or more pending ATM transactions are stored on the mobile device, the customer arrives at the ATM for completing the one or more pending ATM transactions, as represented by block 235. Thus, it will be understood that, in this example embodiment, the mobile device and/or the customer execute the portions of the process flow 200 represented by blocks 205-230 before the customer arrives at the ATM for completing the one or more pending ATM transactions. For example, in some embodiments, the customer and/or the mobile device perform one or more (or all) of the portions of the process flow 200 represented by blocks 205-230 while the customer is waiting in line at the ATM for other ATM customers to complete their transactions. As another example, in some embodiments, the customer and/or the mobile device perform one or more (or all) of the portions of the process flow 200 represented by blocks 205-230 while the customer is at home, at work, and/or as the customer is traveling to the ATM for completing the pending ATM transactions.

After the customer arrives at the ATM, the customer (and/or the mobile device) is identified and/or authenticated at the ATM, as represented by block 240. In some embodiments, the customer is identified and/or authenticated based at least partially on one or more credentials the customer presents to the ATM, such as, for example, a username, password, PIN, debit or ATM card, biometric information, and/or the like. It will be understood that these one or more credentials can be associated with the customer, with the mobile device, and/or with the account that is involved in the one or more pending ATM transactions. In some embodiments, the ATM will not complete the one or more pending ATM transactions unless and/or until the ATM identifies and/or authenticates the customer (and/or the mobile device).

After authenticating the customer (and/or mobile device), the ATM prompts the customer to transfer any pending ATM transactions from the customer's mobile device to the ATM, as represented by block 245. In some embodiments, when the ATM prompts the customer, as represented by block 245, the ATM does not know whether the mobile device has any pending ATM transactions stored therein. In addition to the ATM prompting the customer, the mobile device presents information associated with the pending ATM transaction(s) to the customer, and prompts the customer to select (e.g., select, confirm, choose, etc.) one or more of the pending ATM transaction(s) for transfer, as represented by block 250. In some embodiments, the mobile device presents this information to the customer as a result of customer operating the mobile device to view the pending ATM transactions stored therein.

It will be understood that the prompting and/or presenting referred to in blocks 215, 245, 250, and/or 270 may include sending and/or presenting one or more questions, instructions, requests, messages, graphics, sounds, telephone calls, text messages, SMS messages (e.g., traditional SMS messages, 2-way SMS messages, etc.), actionable alerts, instant messages, voice messages, voice recordings, interactive voice response (IVR) communications, pages, emails, user interfaces, dashboards, communications specific to one or more social media networks (e.g., Facebook®, Twitter®, MySpace®, etc.) and/or applications (e.g., a mobile banking application, ATM application, etc.), and/or the like. For example, in some embodiments where the ATM includes a speaker, the ATM is configured to output one or more audible instructions to the customer that instruct the customer to transfer the pending ATM transaction(s) to the ATM. As another example, in some embodiments, the mobile device renders and/or presents a web page to the customer that: (a) shows the customer what pending ATM transaction(s) exist on the mobile device; and/or (b) invites the customer to use an input feature shown in the web page (e.g., selectable button, link, etc.) to select the one or more pending ATM transactions for transfer. Also, in some embodiments, the mobile device and/or the ATM are configured to prompt the customer by using pre-recorded and/or dynamically generated video and/or audio (e.g., which may include one or more menu options, etc.) that instructs the customer how to proceed.

After the mobile device prompts the customer, the customer selects one or more of the presented pending ATM transactions for transfer, as represented by block 255. The customer may select the presented pending ATM transaction(s) in any way. For example, in some embodiments, the customer selects the pending ATM transaction(s) by using one or more input features (e.g., physical and/or digital buttons, microphones, etc.) provided by the mobile device. In other embodiments, the customer selects the pending ATM transaction(s) by using one or more input features displayed and/or otherwise provided in association with a mobile banking application that executes on the mobile device. It will be understood that that customer does not have to select all of the presented pending ATM transactions for transfer. Indeed, in some alternative embodiments not shown, the customer does not select any of the presented pending ATM transaction(s) for transfer, which may end the process flow 200 or require the customer to initiate and complete an ATM transaction using conventional methods (e.g., selecting the type of ATM transaction on the ATM user interface, inputting a transaction amount, etc.).

After selecting which of the presented pending ATM transaction(s) to transfer, the customer operates the mobile device to transfer the pending ATM transaction(s) from the mobile device directly to the ATM, as represented by block 260. For example, in some embodiments, the mobile device and the ATM each have NFC interfaces, and the customer positions the NFC interface of the mobile device proximate to (e.g., within four inches of, within one foot of, within one yard of, etc.) the NFC interface of the ATM in order to transfer the pending ATM transaction(s) from the mobile device directly to the ATM. As another example, in some embodiments, the customer presses a “TRANSFER” button on the user interface of the mobile device to initiate a communications link (e.g., LAN, Bluetooth® connection, RF link, IR link, secure, unsecure, etc.) with the ATM and/or to push the pending ATM transactions from the mobile device directly to the ATM. In some embodiments, the ATM is configured to retrieve the pending ATM transactions directly from the mobile device instead of the mobile device transmitting the pending ATM transactions from the mobile device directly to the ATM. After the customer operates the mobile device to transfer the pending ATM transactions, the pending ATM transaction(s) are transferred from the mobile device directly to the ATM, as represented by block 265. In some alternative embodiments not shown, the pending ATM transactions(s) can be transferred from the mobile device indirectly to the ATM (e.g., via one or more back end servers and/or other apparatuses, etc.).

After receiving the pending ATM transaction(s) from the mobile device, the ATM presents information associated with the pending ATM transaction(s) to the customer and prompts the customer to select (e.g., select, confirm, choose, etc.) one or more of the presented ATM transaction(s) for completion, as represented by block 270. After the mobile device prompts the customer, the customer selects one or more of the presented pending ATM transactions for completion, as represented by block 275. It will be understood that the ATM can be configured to prompt the customer and present information to the customer in any of the same or similar ways described above in connection with the mobile device.

After the customer selects one or more of the presented pending ATM transaction(s), the ATM sends, to an authorization server, one or more authorization requests for completing the selected pending ATM transactions, as represented by block 280. In some embodiments, the authorization request(s) identify and/or describe the selected pending ATM transaction(s), the customer, the account(s) involved in the pending ATM transaction(s), the ATM, and/or the like. After sending the one or more authorization requests, the ATM receives approval from the authorization server to complete one or more of the selected pending ATM transactions, as represented by block 285. Thereafter, the ATM completes one or more of the selected pending ATM transactions, as represented by block 290. After the selected pending ATM transaction(s) are completed, the customer leaves the ATM, as represented by block 295.

Of course, it will also be understood that the embodiment illustrated in FIG. 2 is merely exemplary and that other embodiments may vary without departing from the scope and spirit of the present invention. For example, in some alternative embodiments, the ATM is configured to complete the one or more selected pending ATM transactions automatically after the customer selects the pending ATM transaction(s) for completion so that the pending ATM transaction(s) are completed without any additional action by the customer. As another example, in some alternative embodiments, after the pending ATM transaction(s) are transferred from the mobile device to the ATM, the ATM automatically completes the one or more pending ATM transactions without any further action taken by the customer. For example, in some embodiments, where the mobile device and the ATM each have an NFC interface, the customer may only need to present his credentials to the ATM, hold the NFC interface of the mobile device proximate to the NFC interface of the ATM to transfer the pending ATM transaction(s), and then the pending ATM transaction(s) are automatically completed by the ATM.

As still another example, in some alternative embodiments, the ATM is configured to determine whether the mobile device is associated with the customer, a debit/ATM card, and/or with an account involved in one or more of the pending ATM transactions. For example, in some embodiments, the ATM is configured to query an account datastore in order to determine whether the mobile device that transferred the pending ATM transaction(s) to the ATM has previously been registered to the account and/or authorized by the customer to initiate and/or transfer pending ATM transaction(s).

In addition, it will also be understood that the mobile device and/or the ATM involved in the process flow 200 can be configured to perform one or more portions of the process flow 200 in real time, in substantially real time, and/or at one or more predetermined times. The ATM and/or mobile device may be configured to perform any of the portions of the process flow 200 represented by blocks 205-295 upon or after one or more triggering events (which, in some embodiments, is the performance of one or more of the other portions of the process flow 200). In addition, in some embodiments, the mobile device and/or the ATM (and/or a customer thereof) is configured to perform one or more portions (or combinations of portions) of the process flow 200, from start to finish, within moments, seconds, and/or minutes (e.g., within approximately 1-15 minutes, etc.).

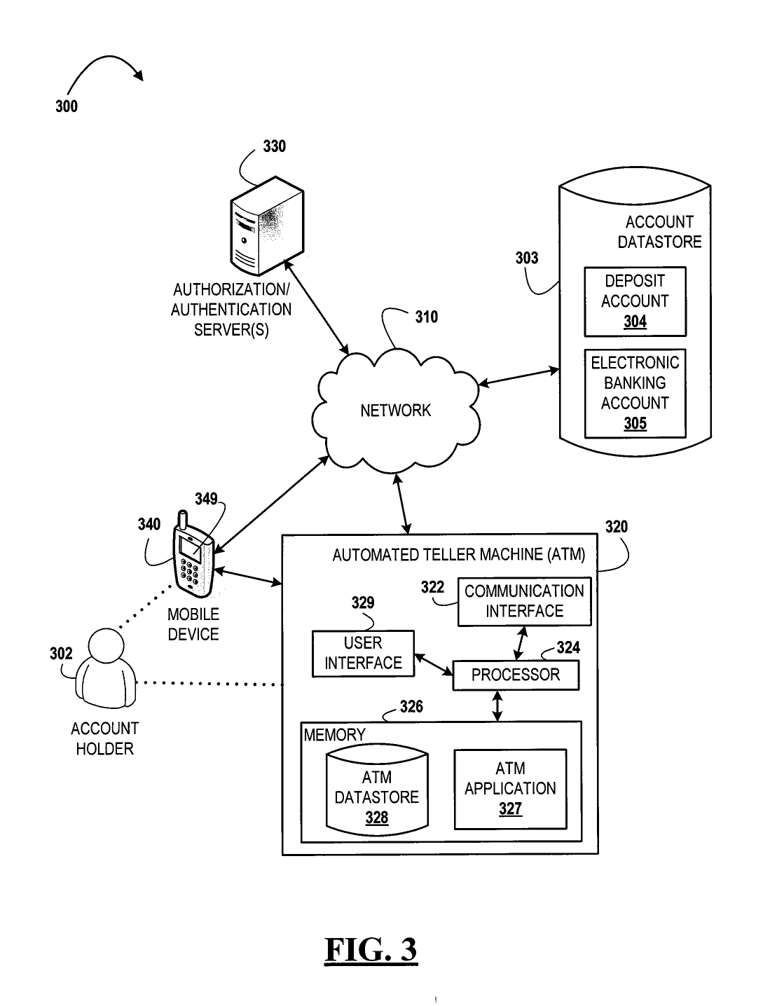

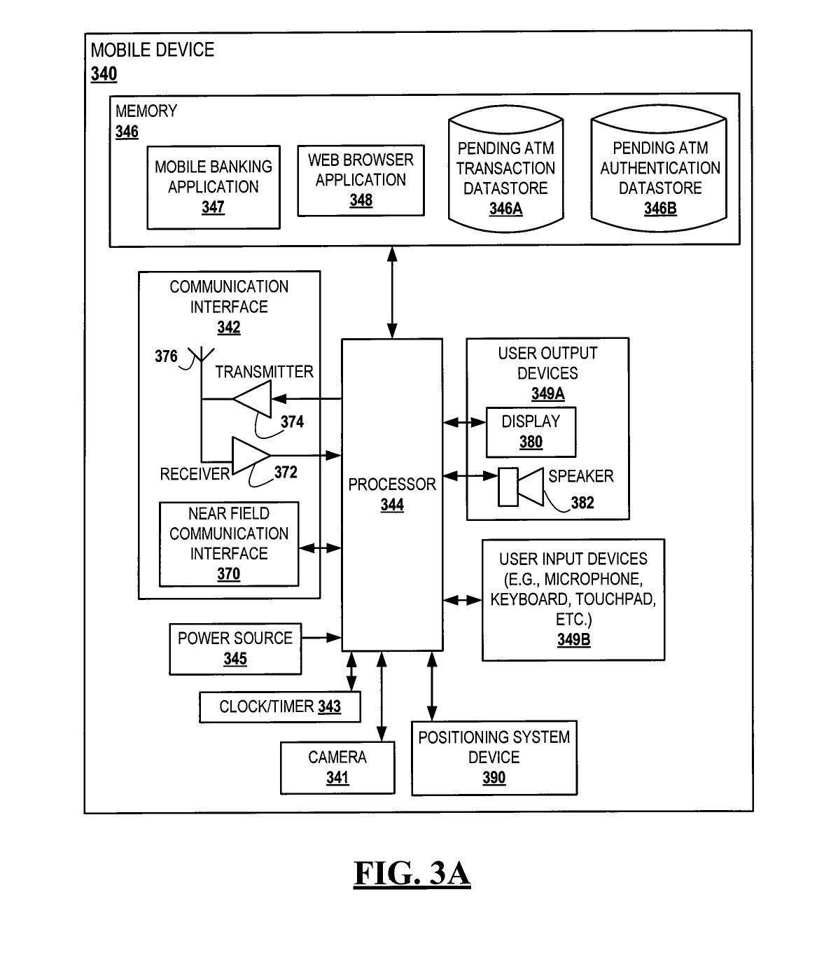

Referring now to FIG. 3, a system 300 for initiating and completing pending ATM transactions and/or pending ATM authentications is provided, in accordance with an embodiment of the present invention. As illustrated, the system 300 includes a network 310, an ATM 320, one or more authorization/authentication servers 330 (sometimes collectively referred to herein as “authorization server 330” for simplicity), an account datastore 303, and a mobile device 340. As shown, the account datastore 303 includes a deposit account 304 and an electronic banking account 305. In this example embodiment, the deposit account 304 (e.g., checking account, savings account, investment account, etc.) is associated with the electronic banking account 305 (e.g., online banking account, mobile banking account, etc.). FIG. 3 also shows the account holder 302, who holds the deposit account 304 and has access to the ATM 320 and to the mobile device 340. In accordance with some embodiments, a single bank maintains the ATM 320, the account datastore 303, and the authorization server 330. In such embodiments, the holder 302 is a customer of the bank. Also, in accordance with some embodiments, the mobile device 340 is associated with the holder 302, and/or is carried, operated, controlled, possessed, and/or owned by the holder 302.

As shown in FIG. 3, the ATM 320, the authorization server 330, and the mobile device 340 are each operatively and selectively connected to the network 310, which may include one or more separate networks. The network 310 may include one or more interbank networks, telephone networks, telecommunication networks, cellular networks, NFC networks, local area networks (LANs), wide area networks (WANs), and/or global area networks (GANs) (e.g., the Internet, etc.). It will also be understood that the network 310 may be secure and/or unsecure and may also include wireless and/or wireline technology. Also, as shown in FIG. 3, the mobile device 340 is directly, selectively, and/or operatively connected to the ATM 320 via one or more wireline and/or wireless connections.

Each communication interface described herein, including the communication interface 342, generally includes hardware, and, in some instances, software, that enables a portion of the system 300, such as the mobile device 340, to send, receive, and/or otherwise communicate information to and/or from the communication interface of one or more other portions of the system 300. Each communication interface described herein can include a modem, network interface controller (NIC), NFC interface, network adapter, network interface card, transceiver, antenna, transmitter, receiver, and/or some other electronic communication device that operatively connects one apparatus to another.

Each processor described herein, including the processor 344, generally includes circuitry for implementing the audio, visual, and/or logic functions of that portion of the system 300. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the mobile banking application 347 of the memory 346 of the mobile device 340.

Each memory device described herein, including the memory 346 for storing the mobile banking application 347 and other information, may include any computer-readable medium. For example, the memory may include temporary and/or volatile memory, such as volatile random access memory (RAM) having a cache area for the temporary storage of data. Memory may also include non-temporary, non-volatile, and/or long-term persistent memory, which may be embedded and/or may be removable. The non-volatile memory may additionally or alternatively include an EEPROM, flash memory, and/or the like. The memory may store any one or more of portions of information used by the apparatus in which it resides to implement the functions of that apparatus.

Each user interface described herein, including the user interfaces 329 and 349, generally includes one or more user output devices for presenting information and/or one or more items to a user (e.g., the holder 302, etc.), such as, for example, one or more displays, speakers, receipt printers, dispensers (e.g., cash dispensers, ticket dispensers, merchandise dispensers, etc.), and/or the like. In some embodiments, the user interface additionally or alternatively includes one or more user input devices, such as, for example, one or more buttons, keys, dials, levers, directional pads, joysticks, keyboards, mouses, accelerometers, controllers, microphones, touchpads, touchscreens, haptic interfaces, scanners, biometric readers, motion detectors, cameras, card readers (e.g., for reading the magnetic strip on magnetic cards such as ATM, debit, credit, and/or bank cards, etc.), deposit mechanisms (e.g., for depositing checks and/or cash, etc.), and/or the like for receiving information from one or more items and/or from the user (e.g., the holder 302, etc.).

Each datastore described herein, including the pending ATM transaction datastore 346A, the pending ATM authentication datastore 346B, the ATM datastore 328, and the account datastore 303, can be configured to store any type and/or amount of information. For example, in some embodiments, the pending ATM transaction datastore 346A is configured to store transaction information associated with one or more pending ATM transactions. As another example, in some embodiments, the pending ATM authentication datastore 346B is configured to store authentication information associated with one or more pending ATM authentications. In some embodiments, the pending ATM transaction datastore 346A and/or the pending ATM authentication datastore 346B include one or more queues, lists, tables, dashboards, ledgers, etc. for organizing, displaying, and/or storing one or more pending ATM transactions and/or pending ATM authentications. As still another example, in some embodiments, the ATM datastore 328 is configured to store information associated with transferring transaction information associated with pending ATM transaction(s) from a mobile device to the ATM 320. The datastores may include any one or more storage devices, including, but not limited to, datastores, databases, and/or any of the other storage devices typically associated with a mobile device, server, and/or computer system. It will also be understood that the datastores may store information in any known way, such as, for example, by using one or more computer codes and/or languages, alphanumeric character strings, data sets, figures, tables, charts, links, documents, and/or the like. Further, in some embodiments, the datastores include information associated with one or more applications, such as, for example, the mobile banking application 347 and/or the ATM application 327. In some embodiments, each datastore provides a real-time or near real-time representation of the information stored therein, so that, for example, when a processor accesses that datastore, the information stored therein is current or nearly current.

Referring now to FIG. 3A, a block diagram is provided that illustrates the mobile device 340 of FIG. 3 in more detail, in accordance with an embodiment of the present invention. In some embodiments, the mobile device 340 is a mobile phone, but in other embodiments, the mobile device 340 can include and/or be embodied as any other mobile device described and/or contemplated herein. The mobile device 340 can be configured to initiate, perform, complete, and/or facilitate any portion of any embodiment described and/or contemplated herein as being initiated, performed, completed, and/or facilitated by a mobile device. As shown in FIG. 3A, the mobile device 340 includes a processor 344 operatively connected to memory 346, user output devices 349A, user input devices 349B, a communication interface 342, a power source 345, a clock or other timer 343, a camera 341, and a positioning system device 390.

The processor 344 may include the functionality to encode and interleave messages and data prior to modulation and transmission. The processor 344 can additionally include an internal data modem. Further, the processor 344 may include functionality to operate one or more software programs, which may be stored in the memory 346. For example, the processor 344 may be capable of operating a connectivity program, such as a web browser application 348. The web browser application 348 may then allow the mobile device 340 to transmit and receive web content, such as, for example, location-based content and/or other web page content, according to a Wireless Application Protocol (WAP), Hypertext Transfer Protocol (HTTP), and/or the like.

The processor 344 is configured to use the communication interface 342 to communicate with one or more other devices on the network 310. In this regard, the communication interface 342 includes an antenna 376 operatively coupled to a transmitter 374 and a receiver 372 (together a “transceiver”). The processor 344 is configured to provide signals to and receive signals from the transmitter 374 and receiver 372, respectively. The signals may include signaling information in accordance with the air interface standard of the applicable cellular system of the wireless telephone network 310. In this regard, the mobile device 340 may be configured to operate with one or more air interface standards, communication protocols, modulation types, and access types. By way of illustration, the mobile device 340 may be configured to operate in accordance with any of a number of first, second, third, and/or fourth-generation communication protocols and/or the like. For example, the mobile device 340 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 340 may also be configured to operate in accordance with non-cellular communication mechanisms, such as via a wireless local area network (WLAN) or other communication/data networks.

The communication interface 342 of the mobile device 340 may also include an NFC interface 370. The NFC interface 370 is configured to contactlessly and/or wirelessly send and/or receive information over relatively short ranges (e.g., within four inches, within three feet, etc.). The NFC interface 370 may include a transmitter, receiver, smart card, key card, proximity card, Bluetooth® device, radio frequency identification (RFID) tag and/or reader, and/or the like. In some embodiments, the NFC interface 370 communicates information via radio, IR, and/or optical transmissions. In some embodiments, the NFC interface 370 is configured to operate as an NFC transmitter and/or as an NFC receiver (e.g., an NFC reader, etc.). In some embodiments, the NFC interface 370 enables the mobile device 340 to operate as a mobile wallet. Also, it will be understood that the NFC interface 370 may be embedded, built, carried, and/or otherwise supported in and/or on the mobile device 340. In some embodiments, the NFC interface 370 is not supported in and/or on the mobile device 340, but the NFC interface 370 is otherwise operatively connected to the mobile device 340 (e.g., where the NFC interface 370 is a peripheral device plugged into the mobile device 340, etc.). Other apparatuses having NFC interfaces mentioned herein may be configured similarly.

In some embodiments, the NFC interface 370 of the mobile device 340 is configured to contactlessly and/or wirelessly communicate information to and/or from a corresponding NFC interface of another apparatus (e.g., the ATM 320, etc.). For example, in some embodiments, the mobile device 340 is a mobile phone, the NFC interface 370 is a smart card having transaction information associated with pending ATM transactions stored therein, and the ATM 320 has an NFC reader operatively connected thereto. In such embodiments, when the mobile phone and/or smart card is brought within a relatively short range of the NFC reader, the smart card is configured to wirelessly and/or contactlessly send the transaction information to the NFC reader in order to complete the pending ATM transaction(s).

In addition to the NFC interface 370, the mobile device 340 can have a user interface 349 that is, like other user interfaces described herein, made up of one or more user output devices 349A and/or user input devices 349B. The user output devices 349A include a display 380 (e.g., a liquid crystal display, a touchscreen display, and/or the like) and a speaker 382 and/or other audio device, which are operatively coupled to the processor 344. The user input devices 349B, which allow the mobile device 340 to receive data from a user such as the holder 302, may include any of a number of devices allowing the mobile device 340 to receive data from a user, such as a keypad, keyboard, touch-screen, touchpad, microphone, mouse, joystick, other pointer device, button, soft key, and/or other input device(s). The user interface 349 may also include a camera 341, such as a digital camera.

In some embodiments, the mobile device 340 also includes a positioning system device 390 that can be used to determine the location of the mobile device 340. For example, the positioning system device 390 may include a GPS transceiver. In some embodiments, the positioning system device 390 is at least partially made up of the antenna 376, transmitter 374, and receiver 372 described above. For example, in one embodiment, triangulation of cellular signals may be used to identify the approximate location of the mobile device 340. In other embodiments, the positioning system device 390 includes a proximity sensor and/or transmitter, such as an RFID tag, that can sense or be sensed by devices known to be located proximate an ATM and/or other locations to determine that the mobile device 340 is located proximate these known devices.

The mobile device 340 further includes a power source 345, such as a battery, for powering various circuits and other devices that are used to operate the mobile device 340. Embodiments of the mobile device 340 may also include a clock or other timer 343 configured to determine and, in some cases, communicate actual or relative time to the processor 344 or one or more other devices.

The mobile device 340 also includes a memory 346 operatively connected to the processor 344. The memory 346 can store any of a number of applications which may include computer-executable program code executed by the processor 344 to implement the functions of the mobile device 340 described herein. For example, the memory 346 may include such applications as a web browser application 348 and/or a mobile banking application 347. It will be understood that the web browser application 348 and/or the mobile banking application 347 can be, individually or collectively, operable to initiate, perform, complete, and/or facilitate one or more portions of any embodiment described and/or contemplated herein, such as, for example, any one or more portions of the process flows 100 and/or 200 described herein.

For example, in some embodiments, the mobile banking application 347 is executable to authenticate the holder 302. As another example, in some embodiments, the mobile banking application 347 is executable to prompt (e.g., via the user interface 349) the holder 302 to input, into the mobile device 340, information for initiating one or more pending ATM transactions. As still another example, in some embodiments, the mobile banking application 347 is executable to initiate one or more pending ATM transactions. As another example, in some embodiments, the mobile banking application 347 is executable to store transaction information associated with one or more pending ATM transactions in the pending ATM transaction datastore 346A and/or elsewhere in the memory 346. As another example, in some embodiments, the mobile banking application 347 is executable to store authentication information associated with one or more pending ATM authentications in the pending ATM transaction datastore 346B. As still another example, in some embodiments, the mobile banking application 347 is executable to present information associated with one or more pending ATM transactions to the holder 302 and/or to prompt the holder to select one or more of the presented pending ATM transactions for transfer (e.g., to the ATM 320). As another example, in some embodiments, the mobile banking application 347 is executable to transfer transaction information associated with the one or more pending ATM transactions (and/or authentication information associated with one or more pending ATM authentications) directly and/or indirectly between the mobile device 340 and the ATM 320.

In some embodiments, the mobile banking application 347 and/or the web browser application 348 is executable to enable the holder 302 and/or mobile device 340 to communicate with one or more other portions of the system 300, and/or vice versa. In some embodiments, the mobile banking application 347 and/or the web browser application 348 is additionally or alternatively executable to initiate, perform, complete, and/or otherwise facilitate one or more financial and/or non-financial transactions. In some embodiments, the mobile banking application 347 and/or the web browser application 348 includes one or more computer-executable program code portions for causing and/or instructing the processor 344 to perform one or more of the functions of the mobile banking application 347, web browser application 348, and/or mobile device 340 described and/or contemplated herein. In some embodiments, the mobile banking application 347 and/or the web browser application 348 includes and/or uses one or more network and/or system communication protocols.

In some embodiments, the mobile banking application 347 and/or the web browser application 348 are executable to render and/or otherwise provide a graphical user interface on the display 380 that allows the holder 302 to communicate with the mobile device 340, the ATM 320, the authorization server 330, and/or one or more other portions of the system 300. In some embodiments, the holder 302 can use the mobile banking application 347 and/or the web browser application 348 to access the electronic banking account 309 (e.g., mobile banking account, etc.) that is associated with the deposit account 304. The memory 346 can also store any type and/or amount information used by the mobile device 340, and/or used by the applications and/or the devices that make up the mobile device 340 and/or that are in communication with the mobile device 340, to implement the functions of the mobile device 340 and/or the other systems described and/or contemplated herein. For example, in some embodiments, the memory 346 stores account information (e.g., routing and/or account numbers, account names, etc.), authentication information (e.g., username/passwords, PINs, tokens, biometric information, etc.) associated with one or more pending ATM authentications, and/or transaction information associated with one or more pending ATM transactions in the memory 346, which can include the pending ATM transaction datastore 346A and/or the pending ATM authentication datastore 346B.

Referring again to FIG. 3, the ATM 320 can include any ATM described and/or contemplated herein. Additionally or alternatively, the ATM 320 can be configured to initiate, perform, complete, and/or facilitate any portion of any embodiment described and/or contemplated herein as being initiated, performed, completed, and/or facilitated by an ATM. As illustrated in FIG. 3, the ATM 320 includes a communication interface 322, a processor 324, a user interface 329, and a memory 326 having an ATM application 327 and an ATM datastore 328 stored therein. As shown, the processor 324 is operatively connected to the communication interface 322, the user interface 329, and the memory 326.

As shown in FIG. 3, the memory 326 includes the ATM application 327. It will be understood that the ATM application 327 can be executable to initiate, perform, complete, and/or facilitate one or more portions of any embodiment described and/or contemplated herein, such as, for example, one or more portions of the process flows 100, 200, 500, 600, and/or the portions of the process flow performed by the system 400 and/or the system 700 described herein. For example, in some embodiments, the ATM application 327 is executable to prompt the holder 302 to transfer transaction information associated with one or more pending ATM transactions, and/or transfer authentication information associated with one or more pending ATM authentications, from a mobile device to the ATM 320. As another example, in some embodiments, the ATM application 327 is executable to receive transaction information and/or authentication information from a mobile device. As still another example, in some embodiments, the ATM application 327 is executable to present, to the holder 302 and via the user interface 329, information associated with one or more pending ATM transactions and/or pending ATM authentications. As yet another example, in some embodiments, the ATM application 327 is executable to prompt the holder 302 to select one or more pending ATM transactions for completion. As another example, in some embodiments, the ATM application 327 is executable to send and/or receive an authorization request for completing one or more selected pending ATM transactions. As still another example, in some embodiments, the ATM application 327 is executable to complete one or more pending ATM transactions (e.g., dispense cash associated with a cash withdrawal transaction, etc.). As another example, in some embodiments, the ATM application 327 is executable to determine whether the mobile device 340 is associated with the holder 302 and/or with the account 304.

In some embodiments, the ATM 320 (and/or one or more other portions of the system 300) requires its users to identify and/or authenticate themselves to the ATM 320 before the ATM 320 will initiate, perform, complete, and/or facilitate a transaction. For example, in some embodiments, the ATM 320 is configured (and/or the ATM application 327 is executable) to authenticate an ATM user (e.g., the holder 302) based at least partially on a pending ATM authentication and/or based at least partially on an ATM and/or debit card, smart card, hardware and/or software token, username, password, PIN, biometric information, and/or one or more other credentials that the user presents to the ATM 320. Additionally or alternatively, in some embodiments, the ATM 320 is configured to authenticate a user by using one-, two-, or multi-factor authentication. For example, in some embodiments, the ATM 320 requires two-factor authentication, such that the holder 302 must provide a valid debit card and enter the correct PIN associated with the debit card in order to authenticate the holder 302 to the ATM 320.

In some embodiments, the ATM application 327 is executable to enable the holder 302 and/or ATM 320 to communicate with one or more other portions of the system 300, and/or vice versa. In some embodiments, the ATM application 327 is additionally or alternatively executable to initiate, perform, complete, and/or otherwise facilitate one or more financial and/or non-financial transactions. In some embodiments, the ATM application 327 includes one or more computer-executable program code portions for causing and/or instructing the processor 324 to perform one or more of the functions of the ATM application 327 and/or ATM 320 described and/or contemplated herein. In some embodiments, the ATM application 327 includes and/or uses one or more network and/or system communication protocols.

FIG. 3 also illustrates authorization/authentication server(s) 330, in accordance with some embodiments of the present invention. The authorization/authentication server 330 can include any server and/or apparatus described and/or contemplated herein. Additionally or alternatively, the server 330 can be configured to initiate, perform, complete, and/or facilitate any portion of any embodiment described and/or contemplated herein as being initiated, performed, completed, and/or facilitated by a server and/or apparatus. In some embodiments, the server 330 includes one or more servers, engines, mainframes, personal computers, ATMs, network devices, front end systems, back end systems, and/or the like. It will be understood that the server 330 may include a communication interface, a processor, and a memory, which may include one or more applications and/or datastores.

In some embodiments, the server 330 is configured (and/or an application thereof is executable) to receive transaction information associated with one or more pending ATM transactions and/or authorize those one or more pending ATM transactions for completion. In some embodiments, the server 330 is configured (and/or an application thereof is executable) to receive authentication information associated with one or more pending ATM authentications and/or authorize those one or more pending ATM authentications for completion. In some embodiments, the server 330 is configured to receive, approve, and/or decline one or more authorization and/or authentication requests, including those for completing one or more pending ATM transactions and/or pending ATM authentications. Additionally or alternatively, in some embodiments, the server 330 is configured to determine that the mobile device 340 is authorized by the holder 302 to initiate and/or transfer pending ATM transactions and/or pending ATM authentications, and/or to determine that the mobile device 340 is otherwise associated with the holder 302 and/or the account 304.

In some embodiments, the server 330 is configured to: (a) receive, from the mobile device 340, information associated with one or more inputs, where the one or more inputs were inputted into the mobile device 340 by the holder 302; (b) generate transaction information and/or authentication information based at least partially on the information associated with the one or more inputs (e.g., generate one or more tokens having information associated with the one or more inputs stored therein, etc.); and (c) sending the transaction information and/or the authentication information (e.g., the one or more tokens) to the mobile device 340, so that the mobile device 340 can transfer the transaction information and/or the authentication information (e.g., the one or more tokens) to the ATM 320 for completing one or more pending ATM transactions and/or pending ATM authentications.

In some embodiments, the server 330 is configured to communicate with one or more other portions of the system 300, such as, for example, a datastore included in the authorization server 330, the mobile device 340, and/or the ATM 320, and/or vice versa. Also, in some embodiments, the server 330 includes one or more applications, where those one or more applications include one or more computer-executable program code portions for causing and/or instructing the processor of the server 330 to perform one or more of the functions of the server 330 described and/or contemplated herein. In some embodiments, the server 330 includes and/or uses one or more network and/or system communication protocols.

It will be understood that the embodiments illustrated in FIGS. 3 and 3A are exemplary and that other embodiments may vary. For example, in some embodiments, some or all of the portions of the system 300 are combined into a single portion. Specifically, in some embodiments, the ATM 320 and the server 330 are combined into a single transaction and authorization/authentication apparatus that is configured to perform all of the same functions of those separate portions as described and/or contemplated herein. Likewise, in some embodiments, some or all of the portions of the system 300 are separated into two or more distinct portions. In addition, the various portions of the system 300 may be maintained by the same or separate parties.

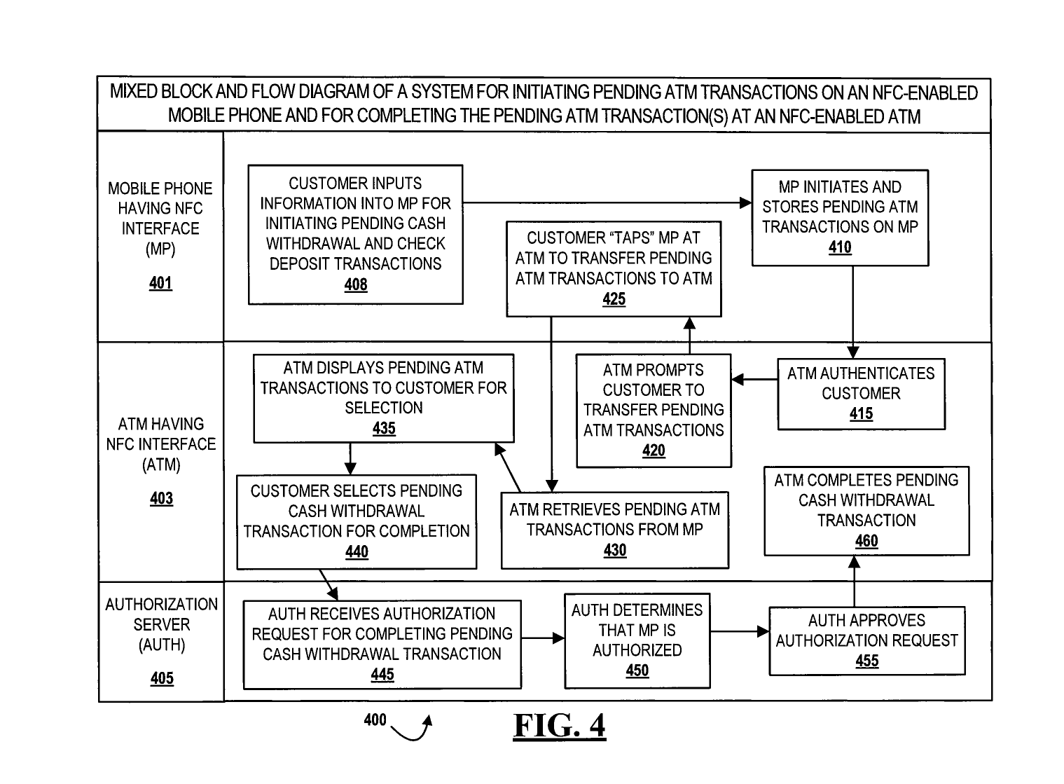

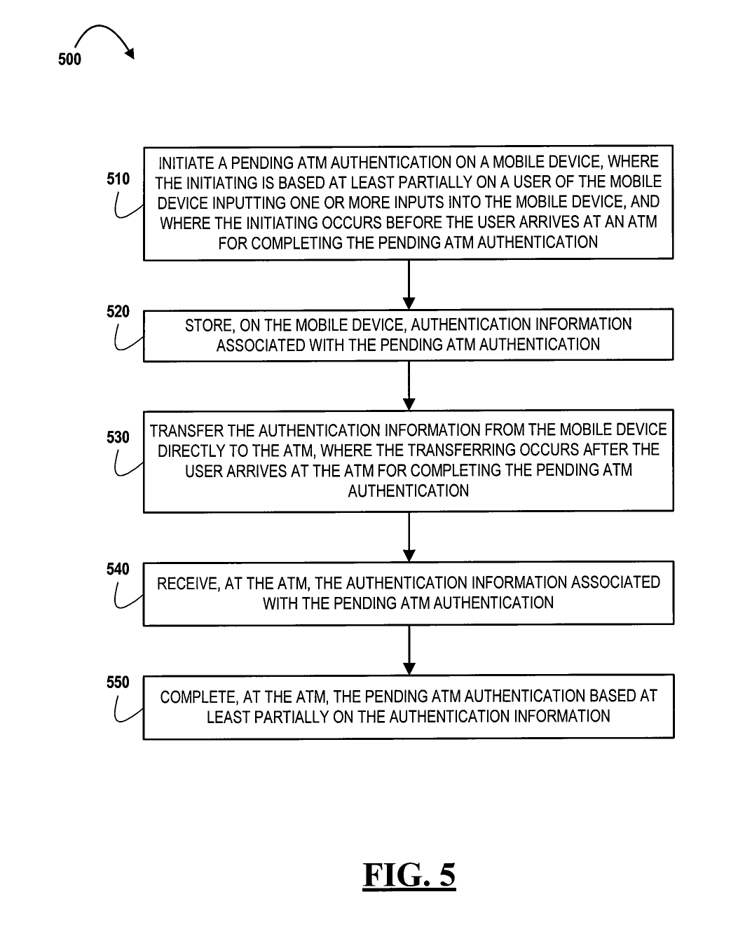

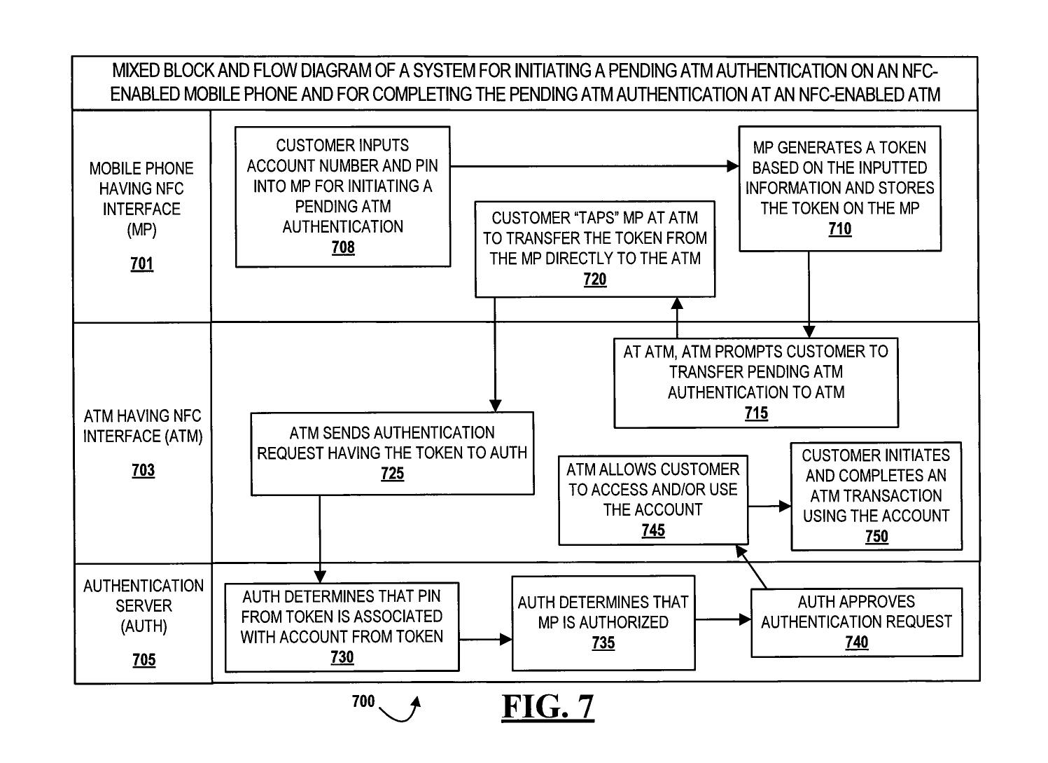

It will be understood that the system 300 and/or one or more portions of the system 300 may include and/or implement any embodiment of the present invention described and/or contemplated herein. For example, in some embodiments, the system 300 (and/or one or more portions of the system 300) is configured to implement any one or more embodiments of the process flow 100 described and/or contemplated herein in connection with FIG. 1, any one or more embodiments of the process flow 200 described and/or contemplated herein in connection with FIG. 2, any one or more embodiments of the process flow described and/or contemplated herein in connection with FIG. 4, any one or more embodiments of the process flow 500 described and/or contemplated herein in connection with FIG. 5, any one or more embodiments of the process flow 600 described and/or contemplated herein in connection with FIG. 5, and/or any one or more embodiments of the process flow described and/or contemplated herein in connection with FIG. 7.

As a specific example, in accordance with an embodiment of the present invention, the mobile device 340 is configured to: (a) initiate a pending ATM transaction on the mobile device 340, where the initiating is based at least partially on the holder 302 inputting one or more inputs into the mobile device 340, and where the initiating occurs before the holder 302 arrives at the ATM 320 for completing the pending ATM transaction, as represented by block 110 in FIG. 1; (b) store, on the mobile device 340, transaction information associated with the pending ATM transaction, as represented by block 120; (c) transfer the transaction information from the mobile device 340 directly to the ATM 320, where the transferring occurs after the holder 302 arrives at the ATM 320 for completing the pending ATM transaction, as represented by block 130. Additionally or alternatively, in some embodiments, the ATM 320 is configured to: (a) receive, at the ATM 320, the transaction information associated with the pending ATM transaction, as represented by block 140; and (b) complete, at the ATM 320, the pending ATM transaction based at least partially on the transaction information, as represented by block 150. In accordance with some embodiments, the ATM 320, the authorization server 330, and/or the mobile device 340 are each configured to send and/or receive one or more instructions to and/or from each other, such that an instruction sent, for example, from the authorization server 330 to the ATM 320 (and/or vice versa) can trigger the ATM 320 (and/or vice versa) to perform one or more portions of an embodiment described and/or contemplated herein.

Referring now to FIG. 4, a mixed block and flow diagram of a system 400 is provided for initiating pending ATM transactions on an NFC-enabled mobile phone and for completing the pending ATM transactions at an NFC-enabled ATM, in accordance with an embodiment of the present invention. It will be understood that the system 400 illustrated in FIG. 4 represents an example embodiment of the process flow 200 described in connection with FIG. 2. As shown, the system 400 includes a mobile phone 401 having an NFC interface (e.g., the mobile device 340 described in FIG. 3), an ATM 403 having an NFC interface (e.g., the ATM 320), and an authorization server 405 (e.g., the authorization server 330). The mobile phone 401, the ATM 403, and the authorization server 405 may each include a communication interface, a user interface, a processor, a memory, an application, and/or a datastore.

In this example embodiment, the mobile phone 401 is operatively and selectively connected to the ATM 403 via the NFC interface of the mobile phone 401 and the NFC interface of the ATM 403. In addition, the ATM 403 is operatively connected to the authorization server 405 via one or more networks (e.g., the network 310). Also, in this example embodiment, the ATM 403 and the authorization server 405 are each maintained by a financial institution, and the mobile phone 401 is maintained by a customer of the financial institution. In this example embodiment, the customer has access to the mobile phone 401 and the ATM 403 (e.g., the customer is a user of the mobile phone 401 and the ATM 403). In addition, the customer carries, controls, owns, and/or operates the mobile phone 401, and the checking account referred to in connection with the system 400 is held by the customer and maintained by the financial institution.

As represented by block 408, the customer operates the mobile phone 401 and inputs information into the mobile phone 401 for initiating a pending cash withdrawal transaction and a pending check deposit transaction that involve the customer's checking account. For example, in some embodiments, the customer uses a user interface displayed at the mobile phone to indicate that the customer desires to withdraw $50 in cash and deposit a check for $250 at an ATM. In some embodiments, the customer identifies a specific time limit (e.g., within twenty minutes, within one hour, within 24 hours, etc.), a specific ATM (e.g., the ATM at College and 5th Streets in Charlotte, N.C., etc.), and/or a specific geographic area (e.g., any ATM within two miles of the customer's current location, etc.) in which to complete the pending ATM transactions. In such embodiments, those transactions are only valid within the selected period of time, at the specific ATM, and/or within the specific geographic area identified by the customer. Although not shown, the mobile phone 401 may also identify and/or authenticate the customer based at least partially on one or more credentials (e.g., username, password, PIN, etc.) the customer provides to the mobile phone 401.

Next, as represented by block 410, the mobile phone 401 initiates and stores the pending cash withdrawal and check deposit transactions (e.g., tokens associated with those transactions, etc.) on the mobile phone 401. For example, in some embodiments, the mobile phone 401 stores a token associated with each of the pending ATM transactions in a queue on the mobile phone 401 and/or in non-volatile, non-temporary, and/or long-term persistent memory in the mobile phone.

Sometime after the mobile phone 401 stores the pending ATM transactions, the customer arrives at an ATM for completing the pending ATM transactions. Thus, in this example embodiment, the mobile phone 401 performs the portions of the process flow represented by blocks 408-410 before the user arrives at the ATM (e.g., while the customer is at home, traveling to the ATM, is waiting in line to use the ATM, etc.). After the customer arrives at the ATM 403, the ATM identifies and/or authenticates the customer, as represented by block 415. For example, in some embodiments, the customer swipes a debit card associated with the checking account and enters a PIN associated with the checking account to authenticate himself to the ATM.

After the customer is authenticated at the ATM 403, the ATM prompts the customer to transfer any pending ATM transactions from the customer's mobile phone to the ATM 403, as represented by block 420. Thereafter, the customer “taps” the mobile phone 401 at the ATM 403 to transfer the pending ATM transactions to the ATM 403. For example, in some embodiments, the customer taps the mobile phone by positioning the NFC interface of the mobile phone 401 within close proximity of the NFC interface of the ATM 403, such that information (e.g., one or more tokens associated with the pending ATM transactions, etc.) is communicated directly between the mobile phone 401 and the ATM 403 via the NFC interfaces. Upon or after the customer taps the mobile phone 401 at the ATM 403, the ATM 403 retrieves the pending ATM transactions (e.g., the token(s)) from the mobile phone 401.

After retrieving the pending ATM transactions, the ATM 403 displays the pending ATM transactions to the customer for selection, as represented by block 435. For example, in some embodiments, the ATM 403 displays, on the touchscreen display of the ATM 403, a first selectable, digital button that reads “PENDING—CASH WITHDRAWAL OF $50” and a second selectable, digital button that reads “PENDING—DEPOSIT CHECK FOR $250.” After displaying the pending ATM transactions to the customer for selection, in this example embodiment, the customer selects the pending cash withdrawal transaction for completion, as represented by block 440. Using the previous example, in some embodiments, the customer selects, on the touchscreen display of the ATM 403, the digital button that reads “PENDING—CASH WITHDRAWAL OF $50.” It will be understood that, in this example embodiment, the customer does not select the pending check deposit transaction for completion because, for example, the customer forgot to bring the check with him to the ATM. Thus, it will be understood that the customer does not have to select for completion all of the pending ATM transactions that are presented to the customer at the ATM and/or all of the pending ATM transactions that are initiated on the mobile phone 401.

After the customer selects the pending cash withdrawal transaction for completion, the ATM 403 sends, and the authorization server 405 receives, an authorization request for completing the cash withdrawal transaction, as represented by block 445. In accordance with some embodiments, the authorization request includes information that, for example, identifies the customer, the checking account associated with the debit card, the amount of cash to be withdrawn, the credentials the customer presented to the ATM 403, and/or the like. As part of processing the authorization request, the authorization server 405 also determines whether the mobile phone 401 is authorized to initiate and/or is otherwise associated with the checking account involved in the cash withdrawal transaction, as represented by block 450. In some embodiments, this involves the authorization server 403 comparing information in the authorization request, which identifies the mobile phone used to initiate the cash withdrawal transaction, with information in an account datastore (e.g., the account datastore 303), which identifies the mobile phone associated with the checking account. In some embodiments, this identifying information includes, for example, the phone number associated with the mobile phone 401, the serial number of the mobile phone 401, and/or the like.

After the authorization server 405 determines that the mobile phone 401 is authorized, the authorization server 405 approves the authorization request, as represented by block 455, and the ATM 403 completes the pending cash withdrawal transaction at the ATM 403, as represented by block 460. In other words, the cash withdrawal transaction that was initiated on the mobile phone 401 is completed at the ATM 403 and results in the ATM 403 dispensing cash to the customer.

Of course, the embodiment illustrated in FIG. 4 is merely exemplary and other embodiments may vary without departing from the scope and spirit of the present invention. For example, in some alternative embodiments, the customer selects, the ATM 403 completes, both the pending cash withdrawal transaction and the pending check deposit transaction. As another example, in some embodiments, the ATM 403 is configured to authenticate the customer using authentication information that is sent to the ATM 403 from the mobile phone 401 during the “tap” referred to in block 425.

In some embodiments, one or more of the portions of the process flow represented by blocks 408-460 are triggered by one or more triggering events, which, in some embodiments, include the performance of one or more of the other portions of the process flow represented by blocks 408-460. Also, in some embodiments, the system 400 is configured to perform one or more portions (or combinations of portions) of the process flow represented by blocks 408-460, from start to finish, within moments, seconds, and/or minutes. For example, in some embodiments, the ATM 403 completes the pending cash withdrawal transaction, as represented by block 460, within seconds or minutes of the customer tapping the mobile phone 401 at the ATM 403, as represented by block 425.

### Pending ATM Authentications

In today's world, an ATM user usually must be authenticated at an ATM before that ATM will initiate, perform, complete, and/or otherwise facilitate an ATM transaction. For example, the user typically presents a debit card and inputs a PIN associated with that debit card at the ATM in order to verify, confirm, and/or prove (e.g., to the ATM, to an authorization apparatus, etc.): (a) the identity of the user; (b) that the user is who he says he is; (b) that the user is authorized to engage in ATM transactions using the debit card; and/or (d) that the user is authorized to engage in transactions involving the account that is associated with the debit card. However, this authentication process can be slow and/or burdensome to perform. In addition, the authentication process may also be vulnerable to fraudsters trying to capture and/or otherwise steal authentication information that is typically presented and/or input at ATMs (e.g., by placing a camera over the ATM keypad, by using a skimmer, etc.).

To improve over these deficiencies, some embodiments of the present invention relate to methods and apparatuses for initiating pending ATM authentications on a mobile device and for completing those pending ATM authentications at an ATM. More specifically, in some embodiments, a user of a mobile device inputs, into the mobile device, authentication information associated with the user (e.g., name, username, password, PIN, social security number, authentication challenge answer, etc.) that can be used (and/or is required) to authenticate the user at the ATM. In some embodiments, the user inputs this authentication information into the mobile device before the user arrives at the ATM for completing an ATM transaction and/or for completing the ATM authentication. In so doing, the mobile device may initiate a pending ATM authentication on the mobile device, such that authentication information associated with the user (e.g., the same or different information input by the user, etc.) can later be transferred from the mobile device directly to the ATM when the user arrives at the ATM for completing the pending ATM authentication. Accordingly, some embodiments of the present invention enable an ATM user to perform at least a portion of the ATM authentication process on a mobile device: (a) while the user is at home, at work, waiting in line to use the ATM, and/or otherwise located remotely from the ATM; and/or (b) before the user arrives at the ATM for completing the ATM authentication and/or one or more ATM transactions (e.g., one or more pending ATM transactions and/or conventional ATM transactions, etc.). Among other things, some embodiments of the present invention may improve customer satisfaction by reducing the amount of necessary interaction between an ATM user and the ATM and/or by reducing the time it takes to authenticate the user at the ATM. In addition, by transferring the authentication information from the mobile device directly to the ATM, some embodiments of the present invention may impede and/or prevent fraudsters from using cameras and/or skimmers to steal authentication information.

Referring now to FIG. 5, a general process flow 500 is provided for initiating a pending ATM authentication on a mobile device and for completing the pending ATM authentication at an ATM, in accordance with an embodiment of the present invention. In some embodiments, the process flow 500 is performed, in combination, by a mobile device (i.e., one or more mobile devices) and an ATM (i.e., one or more ATMs), where each has hardware and/or software configured to perform one or more portions of the process flow 500. In such embodiments, as represented by block 510, the mobile device is configured to initiate a pending ATM authentication on the mobile device, where the initiating is based at least partially on a user of the mobile device inputting one or more inputs into the mobile device, and where the initiating occurs before the user arrives at an ATM for completing the pending ATM authentication. As represented by block 520, the mobile device is also configured to store, on the mobile device, authentication information associated with the pending ATM authentication. In addition, as represented by block 530, the mobile device is configured to transfer the authentication information from the mobile device directly to the ATM, where the transferring occurs after the user arrives at the ATM for completing the pending ATM authentication. Thereafter, as represented by block 540, the ATM is configured to receive the authentication information associated with the pending ATM authentication. Then, as represented by block 550, the ATM is configured to complete the pending ATM authentication based at least partially on the authentication information.

Regarding block 510, the phrase “pending ATM authentication” generally refers to an ATM authentication that has been initiated but not yet completed. In some embodiments, the pending ATM authentication referred to in block 510 is for verifying, confirming, and/or proving: (a) the identity of the user; (b) that the user is who he says he is; (b) that the user is authorized to engage in ATM transactions using a debit card; and/or (d) that the user is authorized to engage in transactions involving an account that is associated with the debit card. In some embodiments, the pending ATM authentication (and/or a conventional ATM authentication) must be completed before the ATM will enable the user to access and/or use an account to engage in an ATM transaction at the ATM. Also, it will be understood that, for simplicity, the phrase “pending ATM authentication” is sometimes used herein to mean “authentication information associated with the pending ATM authentication,” and/or vice versa.

It will be understood that an ATM authentication (and/or a pending ATM authentication) can include any number and/or type of authentication(s) involving a user of an ATM and/or mobile device. In some embodiments, the mobile device is configured to initiate (and/or the ATM is configured to complete) a pending ATM authentication for more than one person, account, debit/ATM card, financial institution, ATM, etc., such that the mobile device may have multiple pending ATM authentications stored on the mobile device at any given time. For example, in some embodiments, the mobile device is configured to initiate a first pending ATM authentication for the user's checking account at Bank A and then initiate a second pending ATM authentication for the user's checking account at Bank B, such that the first pending ATM authentication and the second pending ATM authentication are pending on the mobile device at the same time.

In some embodiments, the pending ATM authentication remains pending for at least one minute, two minutes, one hour, three days, one month, and/or some other non-trivial and/or appreciable period of time before being completed. In some embodiments, once initiated, the pending ATM authentication remains pending on the mobile device indefinitely, even after the pending ATM authentication is transferred to and/or completed at the ATM. In some embodiments, the pending ATM authentication remains pending on the mobile device until deleted and/or removed from the mobile device by the user. However, in some embodiments, the pending ATM authentication is only valid for a predetermined period of time. In other words, in some embodiments, the pending ATM authentication may expire. For example, in some embodiments, a pending ATM authentication is only valid for, and/or will expire after, five minutes, two hours, one day, etc. after being initiated and/or stored on the mobile device. In such embodiments, if the pending ATM authentication is not completed at an ATM within that period of time, the ATM may not be able to complete the pending ATM authentication, and/or the pending ATM authentication (and/or authentication information associated therewith) may be removed, erased, and/or deleted from the mobile device. In some embodiments, the user can select (e.g., via the one or more inputs) when the pending ATM authentication is to expire and/or for how long the pending ATM authentication is to remain valid.

Still referring to block 510, the one or more user inputs may include and/or communicate any amount and/or type of information. In some embodiments, the one or more user inputs include authentication information, and in some embodiments, although not required, this is the same authentication information referred to in the block 530 that is transferred to the ATM. In some embodiments, authentication information is any information that identifies, defines, describes, and/or is otherwise associated with a pending ATM authentication. Exemplary authentication information includes, but is not limited to, account numbers, account nicknames, authentication challenges and/or answers thereto, usernames, passwords, personal identification numbers (PINs), tokens (e.g., authentication code, nickname, software token, access token, information package, data packet, widget, authentication identifier, etc.), biometric information, mobile device identifier (e.g., phone number, serial number, etc. associated with mobile device, etc.), the identity of the party(ies) involved in the pending ATM authentication, the date and/or time that the pending ATM authentication is initiated and/or will be completed, the specific ATM that will complete the pending ATM authentication, how long the pending ATM authentication is valid and/or when the pending ATM authentication will expire, the account(s) and/or card(s) involved in the pending ATM authentication, the status of the pending ATM authentication (e.g., initiated, pending, authorized, completed, etc.), the description of the pending ATM authentication (which, itself, can include any authentication information), and/or the like. In some embodiments, authentication information does not include “transaction information,” as that phrase is defined herein, and/or vice versa. Likewise, in some embodiments, a pending ATM authentication is not the same thing as a “pending ATM transaction,” as that phrase is defined herein, and/or vice versa.

Still referring to block 510, the one or more inputs may be input by the user of the mobile device in any way. For example, in some embodiments, the mobile device includes a keyboard, microphone, and/or one or more other user input devices for inputting the one or more user inputs. As another example, in some embodiments, the mobile device presents, via a touchscreen display of the mobile device, one or more fields, buttons, drop-down menus, and/or other user interface features that enable the customer to input and/or communicate information to the mobile device. In some embodiments, the user actually enters account numbers, usernames, passwords, PINs, answers to authentication challenges, and/or other information into the mobile device, whereas, in other embodiments, the user communicates information to the mobile device by selecting buttons and/or other user interface features that are provided to the user by the mobile device.

Also, it will be understood that the mobile device may initiate the pending ATM authentication in any way. For example, in some embodiments, the pending ATM authentication is initiated when authentication information associated with the pending ATM authentication is communicated to, input into, and/or otherwise received by the mobile device (e.g., as a result of the user inputting the one or more inputs referred to in block 510, as a result of the mobile device receiving the authentication information from an authentication apparatus, etc.). As another example, in some embodiments, the pending ATM authentication is initiated when a token (e.g., information package, widget, authentication code, authentication identifier, etc.) associated with the pending ATM authentication is generated and/or stored on the mobile device.

Regarding block 520, the mobile device can be configured to store the authentication information associated with the pending ATM authentication on the mobile device in any way. In some embodiments, the authentication information is stored in the memory of the mobile device. This memory may be non-temporary, non-volatile, and/or long-term persistent memory, but in some embodiments, in addition to or instead of storing the authentication information in non-temporary, non-volatile, and/or long-term persistent memory, the mobile device stores the authentication information in temporary and/or volatile memory. It will be understood that, in some embodiments, the authentication information is stored on the mobile device if the ATM and/or the user of the mobile device can retrieve the authentication information from the mobile device sometime after the authentication information is stored therein.

In some embodiments, the mobile device is configured to store the authentication information in a pending ATM authentication queue on the mobile device. In some embodiments, this queue is stored in the memory of the mobile device. As a specific example, in some embodiments, the mobile device is configured to generate a token associated with the pending ATM authentication (e.g., information package having information associated with the pending ATM authentication therein, an authentication code, an authentication identifier, etc.) and then place that token into the pending ATM authentication queue. In some embodiments, the token is presented, via a user interface of the mobile device, to the user of the mobile device, such that the user may determine and/or view which pending ATM authentications are stored in the queue. In addition, after arriving at the ATM, the token may be transferred from the pending ATM authentication queue of the mobile device directly to the ATM, such that the ATM can complete the pending ATM authentication based at least partially on the token. In some embodiments, the token is readable and/or executable by the ATM, even though, in some embodiments, the token is not readable to, and/or viewable by, the user of the mobile device. In some embodiments, the token is removed, deleted, and/or erased from the pending ATM authentication queue after the pending ATM authentication is completed by the ATM and/or after the token is transferred to the ATM. Also, it will be understood that the pending ATM authentication queue described and/or contemplated herein may be organized and/or viewable to the user of the mobile device as a list, table, dashboard, ledger, and/or in some other format. Further, in accordance with some embodiments, pending ATM authentications may be stored in the pending ATM authentication queue in the order they were initiated.

Regarding block 530, the phrase “transfer the authentication information” is meant to be understood in its broadest sense. Thus, in some embodiments, the mobile device is configured to send the authentication information from the mobile device to the ATM, whereas, in other embodiments, the ATM is configured to retrieve the authentication information from the mobile device. Also, the phrase “from the mobile device directly to the ATM” is also meant to be understood in its broadest sense. In other words, the authentication information can be transferred in any way, so long as the authentication information is transferred directly between the mobile device and the ATM without being passed through, for example, a host computer, back end network device, a bank server, and/or some other apparatus separate from the mobile device and ATM that has a processor. In some embodiments, the authentication information may pass directly from the mobile device to the ATM via one or more radio, IR, NFC, LAN, Wi-Fi, wireless, and/or wireline interfaces, links, and/or connections. It will be understood that the mobile device can be configured to transfer the authentication information from the mobile device directly to the ATM even when the mobile device is powered off (e.g., using an RFID tag), does not have cellular phone/data service (e.g., using a Wi-Fi connection), and/or does not have a Wi-Fi and/or wireless connection (e.g., using a wireline connection).

Additionally or alternatively, in some embodiments, neither the authentication information, information based at least partially on the one or more inputs referred to in block 510, nor any other information is transferred from (and/or received at) the mobile device during the period of time that extends between the initiating the pending ATM authentication (e.g., inclusive or not inclusive of that event, etc.) and the transferring the authentication information to the ATM (not inclusive of that event). In other words, in such embodiments, the mobile device is configured to perform the portions of the process flow 500 represented by blocks 510-530 itself and without any assistance from another apparatus (e.g., without an authentication apparatus generating the authentication information and sending that authentication information to the mobile device, etc.). In some embodiments, the pending ATM authentication is initiated locally (i.e., on the mobile device) and stored locally until it is time to transfer the pending ATM authentication from the mobile device to the ATM. For example, in some embodiments, the mobile device is configured to: (a) initiate a pending ATM authentication by generating a token on the mobile device, where the token includes information associated with the pending ATM authentication stored therein, and where the mobile device generates the token based at least partially on one or more inputs inputted into the mobile device by a user of the mobile device; (b) store the token on the mobile device upon or after the mobile device generates the token; and (c) then transfer the token from the mobile device directly to the ATM, where the token is never sent from the mobile device (or received at the mobile device) from the time the token is generated until the time the token is transferred to the ATM.

In other embodiments, the mobile device is not configured to perform the portions of the process flow 500 represented by blocks 510-530 entirely on its own or without assistance from another apparatus. For example, in some embodiments, after the user inputs the one or more inputs into the mobile device, the mobile device sends information associated with those one or more inputs to another apparatus (e.g., a host apparatus, back end network device, authentication apparatus, etc.), where that apparatus is configured to generate the authentication information (e.g., a token) based at least partially on the information associated with the one or more inputs. Additionally, in such embodiments, the mobile device is configured to receive, at the mobile device and from the apparatus, the authentication information (e.g., the token). In some of these embodiments, the mobile device transfers the information associated with the one or more inputs to the apparatus, the apparatus generates the authentication information (e.g., the token), and the mobile device receives the authentication information, all before the user arrives at the ATM for completing the pending ATM authentication. Thus, in such embodiments, the authentication information stored on the mobile device is not information that was originally generated by the mobile device; rather, in such embodiments, the authentication information is information that was generated by another apparatus, even though that information was based at least partially on the one or more inputs originally input into the mobile device.

It will be understood that the mobile device is configured to perform the portions of the process flow 500 represented by blocks 510 and 520 at some point when the user of the mobile device is located remotely from the ATM and/or before the user arrives at the ATM for completing the pending ATM authentication. For example, in some embodiments, the user and/or the mobile device performs the portions of the process flow 500 represented by blocks 510 and 520 while the user is at home, at work, and/or as the customer is traveling to the ATM for completing the pending ATM authentication. In some embodiments, the portions of the process flow 500 represented by blocks 510 and 520 are performed while the user is waiting in line at the ATM for other ATM customers to complete their ATM transactions. Also, it will be understood that the mobile device is configured to perform the portion of the process flow 500 represented by block 530 when or after (collectively referred to herein as “after” for simplicity) the user arrives at the ATM for completing the pending ATM authentication. In some embodiments, the customer “arrives at the ATM” when the customer is proximate to, at, and/or within arm's reach of the ATM. Additionally or alternatively, in some embodiments, the customer “arrives at the ATM” when the ATM first interacts with the user of the mobile device and/or ATM.

Regarding block 550, it will be understood that the ATM “completes” the pending ATM authentication when: (a) the user of the ATM is authenticated at the ATM; (b) the mobile device used at the ATM is authenticated at the ATM; and/or (c) the ATM enables the user to access and/or use an account associated with the pending ATM authentication. In some embodiments, the ATM completes the pending ATM authentication before the user of the ATM initiates and/or completes one or more ATM transactions using the ATM. Also, in some embodiments, the ATM is configured to complete the pending ATM authentication automatically after the ATM receives the authentication information from the mobile device, such that the pending ATM authentication is completed without any additional action by the user.

The mobile device and ATM configured to perform the process flow 500 can be configured to perform any of the portions of the process flow 500 represented by blocks 510-550 upon or after one or more triggering events (which, in some embodiments, is one or more of the other portions of the process flow 500). As used herein, a “triggering event” refers to an event that automatically (i.e., without human intervention) triggers the execution, performance, and/or implementation of a triggered action, either immediately, nearly immediately, or sometime after (e.g., within minutes, etc.) the occurrence of the triggering event. For example, in some embodiments, the mobile device is configured such that the mobile device initiating the pending ATM authentication (the triggering event) automatically and immediately or nearly immediately triggers the mobile device to store the authentication information associated with the pending ATM authentication on the mobile device (the triggered action(s)). As another example, in some embodiments, where the mobile device and the ATM each have NFC interfaces, the mobile device is configured to automatically transfer the authentication information associated with the pending ATM authentication to the ATM (triggered action) automatically and immediately or nearly immediately after the NFC interface of the mobile device is positioned proximate to the NFC interface of the ATM (triggering event).

In some embodiments, the mobile device and ATM are configured to automatically perform one or more of the portions of the process flow 500 represented by blocks 510-550, whereas in other embodiments, one or more of the portions of the process flow 500 represented by blocks 510-550 require and/or involve human action (e.g., a user may operate the mobile device and/or the ATM to perform one or more portions of the process flow 500). In addition, it will be understood that, in some embodiments, the mobile device and/or the ATM (and/or the user thereof) is configured to perform one or more portions (or combinations of portions) of the process flow 500, from start to finish, within moments, seconds, and/or minutes (e.g., within approximately 1-15 minutes from start to finish, etc.).

It will be understood that the mobile device and/or the ATM of the process flow 500 can be configured to perform any one or more portions of any one or more embodiments described and/or contemplated herein, including, for example, any one or more portions of the process flows 100, 200, and/or 600 described herein, and/or any of the portions of the process flows performed by the systems 400 and/or 700 described herein. Also, the number, order, and/or content of the portions of the process flow 500 are exemplary and may vary. For example, in some embodiments, the mobile device is configured to store the authentication information associated with the pending ATM authentication in an electronic banking account (e.g., online banking account, mobile banking account, SMS banking account, etc.) associated with the account involved in the pending ATM authentication.

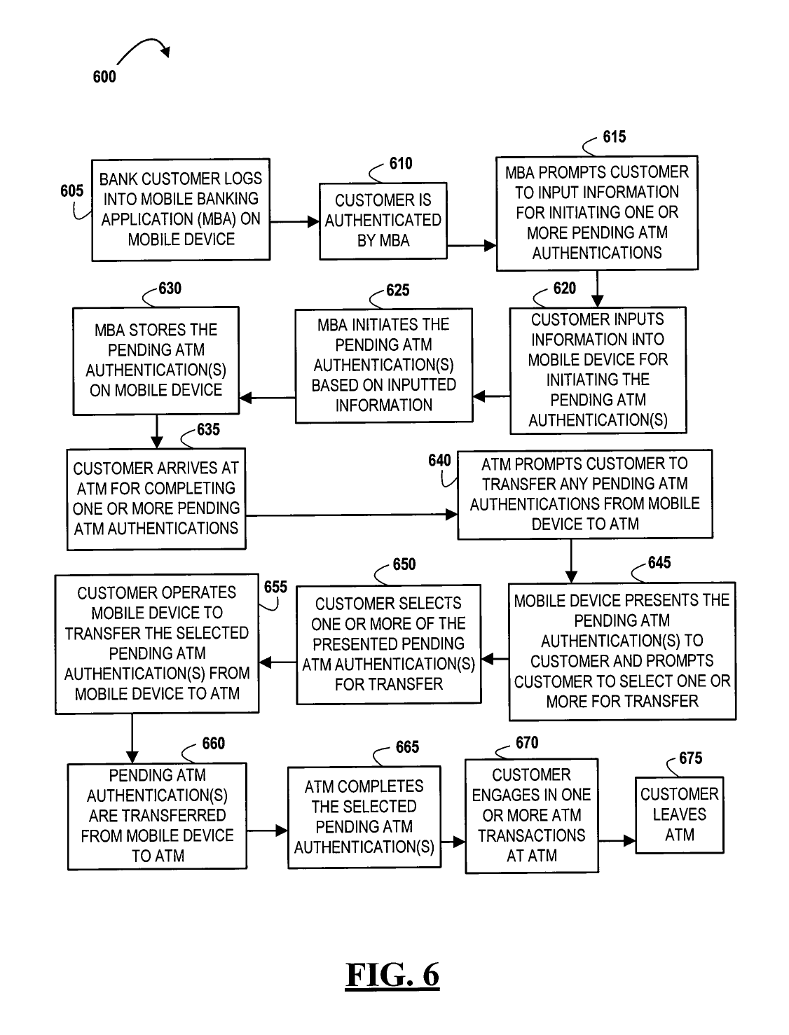

Referring now to FIG. 6, a more-detailed process flow 600 is provided for initiating a pending ATM authentication on a mobile device and for completing the pending ATM authentication at an ATM, in accordance with an embodiment of the present invention. It will be understood that the process flow 600 illustrated in FIG. 6 represents an example embodiment of the process flow 500 described in connection with FIG. 5. It will be understood that one or more portions of the process flow 600 are performed by a mobile device and/or by an ATM, and that the mobile device and the ATM each have the hardware and/or software necessary to perform those one or more portions of the process flow 600. In this example embodiment, the ATM is maintained by a bank for the benefit of its customers. Also in this example embodiment, the customer referred to in the process flow 600 is the user and owner of the mobile device, the user of the ATM, and a customer of the bank. In addition, in this example embodiment, one or more of the pending ATM authentication(s) mentioned in the process flow 600 are associated with an account held by the customer and maintained by the bank. Further, in this example embodiment, the mobile device referred to in the process flow 600 is associated with the customer, is accessible to the customer, and/or is carried, possessed, owned, and/or controlled by the customer during the performance of the portions of the process flow 600.

As represented by block 605, the bank customer logs in to a mobile banking application that executes on the mobile device. As represented by block 610, the customer is identified and/or authenticated by the mobile banking application and/or by the mobile device. After being authenticated, the mobile banking application prompts the customer to input information (e.g., authentication information) for initiating one or more pending ATM authentications, as represented by block 615. For example, in some embodiments, the mobile banking application presents a user interface to the customer that prompts the customer to input (e.g., enter, select, confirm, etc.) an account number, nickname, username, password, PIN, biometric information, answers to authentication challenges, and/or the like for initiating a pending ATM authentication. In some embodiments, the user interface may include one or more fields, buttons, drop-down menus, and/or other user interface features that enable the customer to enter, select, confirm, communicate, and/or otherwise input the information. After being prompted, the customer inputs information into the mobile device for initiating one or more pending ATM authentications, as represented by block 620. It will be understood that the customer may input information for initiating more than one pending ATM authentication. For example, in some embodiments, the customer is prompted to input an account nickname and PIN associated with a checking account and also input an account nickname and PIN associated with a savings account, where both the checking account and the savings account are held by the customer and maintained by the bank. Thus, in such embodiments, it will be understood that the customer may access and/or use more than one account at the ATM.

After the customer inputs the information, the mobile banking application (and/or the mobile device) initiates the one or more pending ATM authentications on the mobile device and/or in the mobile banking application, as represented by block 625. Thereafter, the mobile banking application (and/or the mobile device) stores the one or more pending ATM authentications on the mobile device, as represented by block 630. For example, in some embodiments, a dashboard interface is displayed to the customer that includes one or more tokens (e.g., “BANK A—CHECKING ACT **0931—AUTH PENDING,” “BANK A—SAVINGS ACT **2734—AUTH PENDING,” etc.) for each pending ATM authentication that is initiated on the mobile device. In some embodiments, the dashboard is populated with pending ATM authentications in the order those authentications were initiated. In some embodiments, the dashboard is comprised of non-temporary, non-volatile, and/or long-term persistent memory.

Sometime after the one or more pending ATM authentications are stored on the mobile device, the customer arrives at the ATM for completing the one or more pending ATM authentications, as represented by block 635. Thus, it will be understood that, in this example embodiment, the mobile device and/or the customer execute the portions of the process flow 600 represented by blocks 605-630 before the customer arrives at the ATM for completing the one or more pending ATM authentications. For example, in some embodiments, the customer and/or the mobile device perform one or more (or all) of the portions of the process flow 600 represented by blocks 605-630 while the customer is waiting in line at the ATM for other ATM customers to complete their ATM transactions. As another example, in some embodiments, the customer and/or the mobile device perform one or more (or all) of the portions of the process flow 600 represented by blocks 605-630 while the customer is at home, at work, and/or as the customer is traveling to the ATM for completing the pending ATM authentication(s) and/or one or more ATM transactions.

After the customer arrives at the ATM, the ATM prompts the customer to transfer any pending ATM authentications from the customer's mobile device to the ATM, as represented by block 640. In some embodiments, when the ATM prompts the customer, as represented by block 645, the ATM does not know whether the mobile device has any pending ATM authentications stored therein. In addition to the ATM prompting the customer, the mobile device presents information associated with the pending ATM authentication(s) to the customer, and prompts the customer to select (e.g., select, confirm, choose, etc.) one or more of the pending ATM authentication(s) for transfer, as represented by block 645. In some embodiments, the mobile device presents this information to the customer as a result of the customer operating the mobile device to view the pending ATM authentications stored therein (e.g., as a result of the customer viewing the dashboard interface on the mobile device, etc.).

It will be understood that the prompting and/or presenting referred to in block 615, 640, and/or 645 may include sending and/or presenting one or more questions, instructions, requests, messages, graphics, sounds, telephone calls, text messages, SMS messages (e.g., traditional SMS messages, 2-way SMS messages, etc.), actionable alerts, instant messages, voice messages, voice recordings, interactive voice response (IVR) communications, pages, emails, user interfaces, dashboards, communications specific to one or more social media networks (e.g., Facebook®, Twitter®, MySpace®, etc.) and/or applications (e.g., a mobile banking application, ATM application, etc.), and/or the like. For example, in some embodiments where the ATM includes a speaker, the ATM is configured to output one or more audible instructions to the customer that instruct the user to transfer the pending ATM authentication(s) to the ATM. As another example, in some embodiments, the mobile device renders and/or presents a web page to the customer that: (a) shows the customer what pending ATM authentication(s) exist on the mobile device; and/or (b) invites the customer to use an input feature shown in the web page (e.g., selectable button, link, etc.) to select the one or more pending ATM authentications for transfer. Also, in some embodiments, the mobile device and/or the ATM are configured to prompt the customer by using pre-recorded and/or dynamically generated video and/or audio (e.g., which may include one or more menu options, etc.) that instructs the user how to proceed.

After the mobile device prompts the customer, the customer selects one or more of the presented pending ATM authentications for transfer, as represented by block 650. The customer may select the presented pending ATM authentication(s) in any way. For example, in some embodiments, the customer selects the pending ATM authentication(s) by using one or more input features (e.g., physical and/or digital buttons, microphones, etc.) provided by the mobile device. In other embodiments, the customer selects the pending ATM authentication(s) by using one or more input features displayed and/or otherwise provided in association with a mobile banking application that executes on the mobile device. It will be understood that that user does not have to select all of the presented pending ATM authentications for transfer. Indeed, in some alternative embodiments not shown, the customer does not select any of the presented pending ATM authentication(s) for transfer, which may end the process flow 600 or require the customer to be authenticated at the ATM using conventional methods (e.g., the customer swiping a debit card at ATM and inputting, into the ATM, a PIN associated with that debit card, etc.).

After selecting which of the presented pending ATM authentication(s) to transfer, the customer operates the mobile device to transfer the pending ATM authentication(s) from the mobile device directly to the ATM, as represented by block 655. For example, in some embodiments, the mobile device and the ATM each have NFC interfaces, and the customer positions the NFC interface of the mobile device proximate to (e.g., within four inches of, within one foot of, within one yard of, etc.) the NFC interface of the ATM in order to transfer the pending ATM authentications(s) from the mobile device directly to the ATM. As another example, in some embodiments, the customer presses a “TRANSFER” button on the user interface of the mobile device to initiate a communications link (e.g., LAN, Bluetooth® connection, RF link, IR link, secure, unsecure, etc.) with the ATM and/or to push the pending ATM authentication(s) from the mobile device directly to the ATM. In some embodiments, the ATM is configured to retrieve the pending ATM authentication(s) directly from the mobile device instead of the mobile device transmitting the pending ATM authentication(s) from the mobile device directly to the ATM. After the customer operates the mobile device to transfer the pending ATM authentication(s), the pending ATM authentication(s) are transferred from the mobile device directly to the ATM, as represented by block 660. It will be understood that, in some alternative embodiments not shown, the pending ATM authentication(s) can be transferred from the mobile device indirectly to the ATM (e.g., via one or more back end servers and/or other apparatuses, etc.).

After receiving the pending ATM authentication(s) from the mobile device, the ATM completes the transferred pending ATM authentication(s), as represented by block 665. In some embodiments, the ATM completes the pending ATM authentication(s) by authenticating the customer at the ATM. Additionally or alternatively, the ATM completes the pending ATM authentication by allowing the customer to access and/or use an account associated with the customer. In some embodiments, the ATM completes the pending ATM authentication automatically, and without any action by the customer, after the pending ATM authentication(s) are transferred to the ATM. After the transferred pending ATM authentication(s) are completed, the customer engages in one or more ATM transactions, as represented by block 670. For example, in some embodiments, the customer engages in a cash deposit and/or check deposit transaction at the ATM after the one or more pending ATM authentication(s) are completed. As another example, in some embodiments, the customer completes one or more pending ATM transactions at the ATM before or after the one or more pending ATM authentications are completed, where the one or more pending ATM transactions were transferred from the mobile device directly to the ATM shortly before or after the pending ATM authentications were transferred from the mobile device directly to the ATM. After the customer finishes engaging in ATM transactions at the ATM, the customer leaves the ATM, as represented by block 675.

Of course, it will also be understood that the embodiment illustrated in FIG. 6 is merely exemplary and that other embodiments may vary without departing from the scope and spirit of the present invention. For example, in some alternative embodiments, after the customer arrives at the ATM, the customer operates the mobile device to transfer the pending ATM authentication(s) without being prompted by the ATM. For example, in some alternative embodiments, where the mobile device and the ATM each have an NFC interface, the customer may only need to hold the NFC interface of the mobile device proximate to the NFC interface of the ATM to transfer the pending ATM authentication(s) from the mobile device directly to the ATM. In some of these embodiments, the ATM is configured to automatically complete the transferred pending ATM authentication(s) without any additional action by the customer.

As still another example, in some alternative embodiments, the ATM is configured to determine whether the mobile device is associated with the customer and/or with an account involved in the pending ATM authentication(s). For example, in some embodiments, the ATM is configured to query an account datastore in order to determine whether the mobile device that transferred the pending ATM authentication(s) to the ATM has previously been registered to the account and/or authorized by the customer to initiate and/or transfer pending ATM authentication(s). As another example, in some alternative embodiments, the mobile device is configured to initiate, store, and/or transfer one or more pending ATM transactions (e.g., one or more tokens having transaction information stored therein, etc.), and the ATM is configured to receive and complete those one or more pending ATM transactions. Additionally or alternatively, in some alternative embodiments, one or more portions of the process flow 200 are combined with one or more portions of the process flow 600, or vice versa.

In addition, it will also be understood that the mobile device and/or the ATM involved in the process flow 600 can be configured to perform one or more portions of the process flow 600 in real time, in substantially real time, and/or at one or more predetermined times. The ATM and/or mobile device may be configured to perform any of the portions of the process flow 600 represented by blocks 605-675 upon or after one or more triggering events (which, in some embodiments, is the performance of one or more of the other portions of the process flow 600). In addition, in some embodiments, the mobile device and/or the ATM (and/or a customer thereof) is configured to perform one or more portions (or combinations of portions) of the process flow 600, from start to finish, within moments, seconds, and/or minutes (e.g., within approximately 1-15 minutes, etc.).

Referring now to FIG. 7, a mixed block and flow diagram of a system 700 is provided for initiating a pending ATM authentication on an NFC-enabled mobile phone and for completing the pending ATM authentication at an NFC-enabled ATM, in accordance with an embodiment of the present invention. It will be understood that the system 700 illustrated in FIG. 7 represents an example embodiment of the process flow 600 described in connection with FIG. 6. As shown, the system 700 includes a mobile phone 701 having an NFC interface (e.g., the mobile device 340 described in FIG. 3), an ATM 703 having an NFC interface (e.g., the ATM 320), and an authentication server 705 (e.g., the authorization/authentication server(s) 330). The mobile phone 701, the ATM 703, and the authorization server 705 may each include a communication interface, a user interface, a processor, a memory, an application, and/or a datastore.

In this example embodiment, the mobile phone 701 is operatively and selectively connected to the ATM 703 via the NFC interface of the mobile phone 701 and the NFC interface of the ATM 703. In addition, the ATM 703 is operatively connected to the authentication server 705 via one or more networks (e.g., the network 310). Also, in this example embodiment, the ATM 703 and the authentication server 705 are each maintained by a financial institution, and the mobile phone 701 is maintained by a customer of the financial institution. In this example embodiment, the customer has access to the mobile phone 701 and the ATM 703 (e.g., the customer is a user of the mobile phone 701 and the ATM 703). In addition, the customer carries, controls, owns, and operates the mobile phone 701, and the checking account referred to in connection with the system 700 is held by the customer and maintained by the financial institution.

As represented by block 708, the customer operates the mobile phone 701 and inputs an account number and an associated PIN into the mobile phone 701 for initiating a pending ATM authentication. In some embodiments, the customer identifies a specific time limit (e.g., within twenty minutes, within one hour, within 24 hours, etc.), a specific ATM (e.g., the ATM at College and 5th Streets in Charlotte, N.C., etc.), and/or a specific geographic area (e.g., any ATM within two miles of the customer's current location, etc.) in which to complete the pending ATM authentication. In such embodiments, that pending ATM authentication is only valid within the selected period of time, at the specific ATM, and/or within the specific geographic area identified by the customer. Although not shown, the mobile phone 701 may also identify and/or authenticate the customer based at least partially on one or more credentials (e.g., username, password, PIN, etc.) the customer provides to the mobile phone 701.

Next, as represented by block 710, the mobile phone 701 generates a token (e.g., software token, access token, authentication code, authentication identifier, information package, data packet, widget, etc.) based at least partially on the inputted authentication information. It will be understood that, in this example embodiment, the token includes, is based at least partially on, and/or can be used to determine the authentication information inputted by the customer (i.e., the account number and the PIN). In addition to generating the token, the mobile phone 701 also stores the token on the mobile phone 701, as represented by block 708. In some embodiments, the mobile phone 701 stores the token in non-volatile, non-temporary, and/or long-term persistent memory in the mobile phone 701. In some embodiments, the token is stored on the mobile phone 701, such that the customer may view the token, a representation of the token, and/or the contents of the token in, for example, a dashboard interface displayed on the mobile phone 701. It will be understood that the token is associated with the pending ATM authentication. Further, it will be understood that, in some embodiments, the pending ATM authentication is initiated when the customer inputs the account number and PIN and/or when the mobile phone 701 generates and/or stores the token. In some embodiments, the token is not transferred from the mobile phone 701 from the time the token is generated on the mobile phone 701 until the time the token is transferred to the ATM 703. Additionally or alternatively, in some embodiments, the mobile phone 701 does not receive assistance from, and/or does not communicate with, any other apparatus in order to generate and/or store the token.

Sometime after the mobile phone 701 stores the token associated with pending ATM authentication, the customer arrives at an ATM for completing the pending ATM authentication. Thus, in this example embodiment, the mobile phone 701 performs the portions of the process flow represented by blocks 708-710 before the user arrives at the ATM (e.g., while the customer is at home, traveling to the ATM, is waiting in line to use the ATM, etc.). After the customer arrives at the ATM 703, the ATM 703 prompts the customer to transfer any pending ATM authentications from the customer's mobile phone 701 to the ATM 703, as represented by block 715. Thereafter, the customer “taps” the mobile phone 701 at the ATM 703 to transfer the token associated the pending ATM authentication from the mobile phone 701 directly to the ATM 703. For example, in some embodiments, the customer taps the mobile phone 701 by positioning the NFC interface of the mobile phone 701 within close proximity (e.g., within four inches, etc.) of the NFC interface of the ATM 703, such that information (e.g., the token, the account number and PIN, other authentication information, etc.) is communicated directly between the mobile phone 701 and the ATM 703 via the NFC interfaces.

After the customer taps the mobile phone 701 at the ATM 703, the ATM 703 sends, and the authentication server 705 receives, an authentication request having the token, as represented by block 725. Thereafter, as represented by block 730, the authentication server 705 determines that the PIN from the token is associated with the account from the token by, for example, accessing an account datastore having information associated with the customer's checking account. In some embodiments, the authentication server 705 makes the determination represented by block 730 based at least partially on comparing the token sent in the authentication request to another token stored on the server 705. In addition, as part of processing the authentication request, the authentication server 705 also determines whether the mobile phone 701 is authorized to initiate and/or is otherwise associated with the checking account involved in the pending ATM authentication, as represented by block 735. In some embodiments, this involves the authentication server 703 comparing information in the authentication request that identifies the mobile phone used to initiate the pending ATM authentication (and/or generate the token) with information stored in an account datastore (e.g., the account datastore 303) that identifies the mobile phone associated with the checking account. In some embodiments, this identifying information includes, for example, the phone number associated with the mobile phone 701, the serial number of the mobile phone 701, and/or the like.

After the authentication server 705 determines that the mobile phone 701 is authorized, the authentication server 705 approves the authentication request, as represented by block 740. As a result of the authentication server 705 approving the request, the ATM 703 completes the pending ATM authentication at the ATM 703 by authenticating the customer and/or allowing the customer to access and/or use the checking account via the ATM 703, as represented by block 745. In other words, the pending ATM authentication that was initiated on the mobile phone 701 is completed at the ATM 703. After completing the pending ATM authentication, the customer initiates and/or completes an ATM transaction (which may include one or more pending ATM transactions and/or conventional ATM transactions) at the ATM 703 using the checking account, as represented by block 750.

Of course, the embodiment illustrated in FIG. 7 is merely exemplary and other embodiments may vary without departing from the scope and spirit of the present invention. For example, in some alternative embodiments, instead of sending the authentication request to the authentication server 705, as represented by block 725, the ATM 703 (and not the authentication server 705) is configured to determine that the PIN from the token is associated with the account from the token, for example, by accessing an account database. In some of these alternative embodiments, the ATM 703 is also configured to determine whether the mobile phone 701 is authorized.

In some embodiments, one or more of the portions of the process flow represented by blocks 708-750 are triggered by one or more triggering events, which, in some embodiments, include the performance of one or more of the other portions of the process flow represented by blocks 708-750. Also, in some embodiments, the system 700 is configured to perform one or more portions (or combinations of portions) of the process flow represented by blocks 708-750, from start to finish, within moments, seconds, and/or minutes. For example, in some embodiments, the ATM 703 completes the pending ATM authentication (represented by block 745) within seconds or minutes of the customer tapping the mobile phone 701 at the ATM 703 (represented by block 720).

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, apparatuses, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method comprising:
initiating a pending ATM transaction on a mobile device, wherein the initiating is based at least partially on a user of the mobile device inputting one or more inputs into the mobile device, and wherein the initiating occurs before the user arrives at an ATM for completing the pending ATM transaction;
storing, on the mobile device, transaction information associated with the pending ATM transaction; and
transferring the transaction information from the mobile device directly to the ATM, wherein the ATM is configured to complete the pending ATM transaction based at least partially on the transaction information, and wherein the transferring occurs after the user arrives at the ATM for completing the pending ATM transaction.

2. The method of claim 1, further comprising:
generating, on the mobile device, the transaction information based at least partially on the one or more inputs, wherein the generating the transaction information occurs before the transferring the transaction information.

3. The method of claim 2,
wherein the generating the transaction information comprises generating, on the mobile device, a token based at least partially on the one or more inputs,
wherein the storing the transaction information comprises storing the token on the mobile device, and
wherein the transferring the transaction information from the mobile device directly to the ATM comprises transferring the token from the mobile device directly to the ATM.

4. The method of claim 1, wherein neither the transaction information nor information based at least partially on the one or more inputs is transferred from the mobile device during the period of time that extends between the initiating the pending ATM transaction and the transferring the transaction information.

5. The method of claim 1, further comprising:
authenticating the user at the mobile device before the initiating the pending ATM transaction.

6. The method of claim 1, further comprising:
prompting, at the mobile device, the user to input the one or more inputs into the mobile device.

7. The method of claim 1, further comprising:
authenticating the user at the ATM after the user arrives at the ATM for completing the pending transaction.

8. The method of claim 1, further comprising:
prompting, at the ATM, the user to transfer the transaction information from the mobile device to the ATM.

9. The method of claim 1, further comprising:
prompting, at the mobile device, the user to select the pending ATM transaction for transfer.

10. The method of claim 1, further comprising:
prompting, at the ATM, the user to select the pending ATM transaction for completion, wherein the prompting occurs after the transferring the transaction information.

11. The method of claim 10, further comprising:
completing the pending ATM transaction at the ATM, wherein the completing the pending ATM transaction occurs automatically after the user selects the pending ATM transaction so that the pending ATM transaction is completed without any additional action by the user.

12. The method of claim 1, wherein the transaction information identifies the mobile device and an account held by the user, the method further comprising:
determining, at the ATM, that the mobile device is associated with the account.

13. The method of claim 1, further comprising:
removing the transaction information from the mobile device after the transferring the transaction information.

14. The method of claim 1, further comprising:
completing the pending ATM transaction at the ATM.

15. The method of claim 1, wherein the pending ATM transaction is valid only for a predetermined period of time.

16. The method of claim 1, wherein the pending ATM transaction is valid only for a predetermined ATM.

17. The method of claim 1, wherein the mobile device comprises a first near field communication (NFC) interface and the ATM comprises a second NFC interface, and wherein the transferring the transaction information comprises transferring the transaction information from the first NFC interface directly to the second NFC interface.

18. The method of claim 1, wherein the mobile device comprises a mobile phone.

19. The method of claim 1, wherein the pending ATM transaction comprises a cash withdrawal transaction.

20. A mobile device comprising:
a user interface configured to receive one or more inputs from a user of the mobile device;
a memory device;
a processor operatively connected to the user interface and the memory device, and configured to:
initiate a pending ATM transaction, wherein the processor initiates the pending ATM transaction based at least partially on the one or more inputs, and wherein the processor initiates the pending ATM transaction before the user arrives at an ATM for completing the pending ATM transaction; and
store, in the memory device, transaction information associated with pending ATM transaction; and
a communication interface operatively connected to the processor and configured to:
transfer the transaction information from the memory device to the ATM, wherein the ATM is configured to complete the pending ATM transaction based at least partially on the transaction information, and wherein the communication interface transfers the transaction information after the user arrives at the ATM for completing the pending ATM transaction.

21. The mobile device of claim 20, wherein the processor is further configured to:
generate the transaction information based at least partially on the one or more inputs, wherein the processor generates the transaction information before the communication interface transfers the transaction information.

22. The mobile device of claim 20, wherein neither the transactions information nor information based at least partially on the one or more inputs is transferred from the mobile device during the period of time that extends between the processor initiating the pending ATM transaction and the communication interface transferring the transaction information.

23. The mobile device of claim 20, wherein the processor is further configured to:
authenticate the user before the processor initiates the pending ATM transaction.

24. The mobile device of claim 20, wherein the processor is further configured to:
prompt, via the user interface, the user to input the one or more inputs into the mobile device.

25. The mobile device of claim 20, wherein the processor is further configured to:
prompt, via the user interface, the user to select the pending ATM transaction for transfer.

26. The mobile device of claim 20, wherein the pending ATM transaction is valid only for a predetermined period of time.

27. The mobile device of claim 20, wherein the pending ATM transaction is valid only for a predetermined ATM.

28. The mobile device of claim 20, wherein the communication interface comprises a first NFC interface and the ATM comprises a second NFC interface, and wherein the communication interface transfers the transaction information by transferring the transaction information from the first NFC interface directly to the second NFC interface.

29. A computer program product comprising a non-transitory computer-readable medium, wherein the non-transitory computer-readable medium comprises one or more computer-executable program code portions that, when executed by a mobile device, cause the mobile device to:
initiate a pending ATM transaction on the mobile device, wherein the mobile device initiates the pending ATM transaction based at least partially on a user of the mobile device inputting one or more inputs into the mobile device, and wherein the mobile device initiates the pending ATM transaction before the user arrives at an ATM for completing the pending ATM transaction;
store, on the mobile device, transaction information associated with the pending ATM transaction; and
transfer the transaction information from the mobile device directly to the ATM, wherein the ATM is configured to complete the pending ATM transaction based at least partially on the transaction information, and wherein the mobile device transfers the transaction information after the user arrives at the ATM for completing the pending ATM transaction.

30. The computer program product of claim 29, wherein the one or more computer-executable program code portions, when executed by the mobile device, cause the mobile device to:
generate the transaction information based at least partially on the one or more inputs, wherein the mobile device generates the transaction information before the mobile device transfers the transaction information.

31. The computer program product of claim 29, wherein neither the transaction information nor information based at least partially on the one or more inputs is transferred from the mobile device during the period of time that extends between the mobile device initiating the pending ATM transaction and the mobile device transferring the transaction information.

32. The computer program product of claim 29, wherein the one or more computer-executable program code portions, when executed by the mobile device, cause the mobile device to:
authenticate the user before the mobile device initiates the pending ATM transaction.

33. The computer program product of claim 29, wherein the one or more computer-executable program code portions, when executed by the mobile device, cause the mobile device to:
prompt the user to input the one or more inputs into the mobile device.

34. The computer program product of claim 29, wherein the one or more computer-executable program code portions, when executed by the mobile device, cause the mobile device to:
prompt the user to select the pending ATM transaction for transfer.

35. The computer program product of claim 29, wherein the pending ATM transaction is valid only for a predetermined period of time.

36. A method comprising:
receiving, at an ATM and directly from a mobile device, transaction information associated with one or more pending ATM transactions; and
completing, at the ATM, the one or more pending ATM transactions based at least partially on the transaction information.

37. The method of claim 36, further comprising:
prompting, via a user interface associated with the ATM, the user to transfer the transaction information from the mobile device directly to the ATM.

38. The method of claim 36, wherein the completing the one or more pending ATM transactions occurs automatically after the receiving the transaction information so that the one or more pending ATM transactions are completed without any additional action by a user of the ATM.

39. The method of claim 36, wherein the transaction information comprises information associated with an account, the method further comprising:
determining, at the ATM, that the mobile device is associated with the account.

40. The method of claim 36, wherein the one or more pending ATM transactions are valid only for a predetermined period of time.

41. The method of claim 36, wherein the one or more pending ATM transactions are valid only for the ATM.

42. The method of claim 36, wherein the mobile device comprises a first NFC interface and the ATM comprises a second NFC interface, and wherein the receiving the transaction information comprises receiving the transaction information at the second NFC interface directly from the first NFC interface.

43. The method of claim 36, further comprising:
prompting, via a user interface associated with the ATM, the user to select one or more of the one or more pending ATM transactions for completion; and
receiving, via the user interface, the user's one or more selections.

44. The method of claim 36, further comprising:
authenticating the user at the ATM.
